(19) United States
(12) Patent Application Publication
(10) Pub. No.: US 2024/0427302 A1
(43) Pub. Date: Dec. 26, 2024

(54) CONTEXTUAL CONTROL

(71) Applicant: Fraunhofer-Gesellschaft zur Förderung der angewandten Forschung e.V., München (DE)

(72) Inventors: Thomas HAUSTEIN, Berlin (DE); Paul Simon Holt LEATHER, Berlin (DE)

(73) Assignee: Fraunhofer-Gesellschaft zur Förderung der angewandten Forschung e.V., München (DE)

(21) Appl. No.: 18/828,977

(22) Filed: Sep. 9, 2024

Related U.S. Application Data
(63) Continuation of application No. PCT/EP2023/055763, filed on Mar. 7, 2023.

(30) Foreign Application Priority Data
Mar. 9, 2022 (EP) 22161028.0

(51) Int. Cl. G05B 19/042; G05B 15/02

(52) U.S. Cl. CPC G05B 19/0426; G05B 15/02

(57) ABSTRACT

A device configured for transmitting a command signal as an instructing device and to an instructed device forming a command chain with the instructing device includes an interface configured for transmitting the command signal. The device further includes a control unit configured for providing an instruction signal including an instruction associated to a target behavior of the instructed device. The device is configured for accessing/using contextual information indicating a context of the command chain and for generating a command from the instruction based on the contextual information. The command is associated with an operation of the instructed device. Alternatively or in addition, the device is configured for providing contextual information indicating a context of the command chain for interpretation of a command belonging to the command chain. The device is configured for transmitting the command signal including the command using the interface.

### CROSS-REFERENCES TO RELATED APPLICATIONS

This application is a continuation of copending International Application No. PCT/EP2023/055763, filed Mar. 3, 2023, which is incorporated herein by reference in its entirety, and additionally claims priority from European Application No. EP 22 161 028.0, filed Mar. 9, 2022, which is incorporated herein by reference in its entirety.

### BACKGROUND OF THE INVENTION

The present invention refers to devices that use contextual information for providing and interpreting commands, e.g., an instructing device and an instructed device, e.g., communicating it in a command chain. The present invention further relates to a system comprising such devices, to methods for operating such devices and/or systems and to a computer program product. The present invention in particular relates to the use of contextual commands in a wireless communication system, WCS.

FIG. 40 shows a schematic block diagram of a process 2000 to be controlled. Process 2000 provides for a relationship between an input 2002 to process 2000 and an output 2004 of process 2000.

### A Control System

A control system is an interconnection of components forming a system configuration that will provide a desired system response. The basis for analysis of a system is the foundation provided by linear system theory, which assumes a cause-effect relationship for the components of a system. Therefore a component or process 2000 to be controlled can be represented by a block as shown in FIG. 40.

The input-output relationship between input 2102 and output 2104 represents the cause-and-effect relationship of the process, which in turn represents a processing of the input signal to provide an output signal variable, often with a power amplification. An open-loop control system utilizes a controller or control actuator 2100 in order to obtain the desired response by output 2004 as shown in the Open-loop control system of FIG. 41.

In contrast to an open-loop control system, a closed-loop control system as shown in FIG. 42 utilizes an additional measure 2200 of the actual output in order to compare 2300 the actual output with the desired output response. The measure of the output is called the feedback signal 2202. A schematic block diagram of a simple closed-loop feedback control system is shown in FIG. 42.

A standard definition of a feedback control system is as follows: a feedback control system is a control system that tends to maintain a prescribed relationship of one system variable to another by comparing functions of these variables and using the difference as a means of control.

A feedback control system often uses a function of a prescribed relationship between the output 2004 and the reference input 2102 to control the process. Often the difference between the output of the process under control and the reference input is amplified and used to control the process so that the difference is continually reduced. The feedback concept has been the foundation for control system analysis and design.

In addition to the simple examples given above, a control system can comprise a combination of further open-loop and closed-loop systems. Furthermore, there might also be multiple inputs to and multiple outputs from the system such as is shown in FIG. 43.

### A Command System

In state-of-the-art, SOTA control loops, a system or process controller is used to control the output of a system or process. Such a controller may use instructions (or a set of instructions) to instantiate the required settings of the system or process. When realized with digital messages, such settings or sequences of settings are often referred to as a device driver—here the device represent an apparatus, a system or a process.

A classic example is a personal computer 3100 with a printer 3200 connected to it such as that shown in FIG. 44 illustrating an example of a personal computer 3100 interfacing with an external device in response to the commands of a user 3300; where the hardware and software configuration includes a printer device driver 3130. The device driver 3130 is a software program installed on the host computer 3100 so that when used together with the computer's operating system 3120 and a further application program 3110—for example a word processor—the correct messages or commands are sent from the PC 3100 to the printer 3200 such that the printer 3200 produces a printed output—for example a document—according to the wishes of the user 3300 via the application program 3110 in use. In this particular example, the system controller (the computer) 3100 needs a software device driver 3130 that is not only specific to the printer 3200 connected to the computer 3100 but also to the operating system 3120 installed on the computer 3100. Generally speaking, any given hardware device will require a device driver 3130 to be installed on the computer 3100 that is specific to both the hardware device 3200 and the operating system 3120.

With reference to the classical example given earlier, in a standardized SOTA system, a library of device drivers might be provided as part of the operating system such that when a new hardware device is connected to the computer 3100 and identifies itself to the computer 3100, the computer 3100 then retrieves the appropriate device driver from its library and, if necessary, installs it.

However, even when the interface between a controller and a controlled system are standardized at the instruction set level, an a priori knowledge of the instruction sets and sequences thereof has to be known. When considering together with the increasing complexity of devices, systems, processes and combinations thereof—for example, their interaction, interdependency, concatenation, coordination, scheduling, orchestration, cooperation and calibration—the utilization of certain features, might not be possible by a standard controller.

Non-proprietary standard-compliant products has to satisfy the requirement of system interoperability. This means that the controllers and devices made by various manufacturers can be used interchangeably as the components of a fully functional system. Therefore, and in combination with the innovative and “future proof” use of controllable systems, devices and processes will require new forms of interfaces between the controller or command and the system, entity or process be controlled.

Thus, there is a need for enhancing interoperability of devices.

An object of the present invention is, thus, to provide for a concept to enhance interoperability, in particular but not limited to, the field of wireless communications.

The inventors have found that a high degree of interoperability may be obtained when using contextual information on the side of an instructing device and/or an instructed device, which allows for an assumption as to how the instructed device will interpret provided instructions, how the instructing device has meant the provided instructions/commands when interpreting the same, respectively.

### SUMMARY

An embodiment may have a device configured for transmitting a command signal as an instructing device and to an instructed device forming a command chain with the instructing device, the device comprising: an interface configured for transmitting the command signal; a control unit configured for providing an instruction signal comprising an instruction associated to a target behaviour of the instructed device; wherein the device is configured for accessing/using contextual information indicating a context of the command chain and for generating a command from the instruction based on the contextual information; wherein the command is associated with an operation of the instructed device; or providing contextual information indicating a context of the command chain for interpretation of a command belonging to the command chain wherein the device is configured for transmitting the command signal comprising the command using the interface.

Another embodiment may have a device configured for operating based on a received command as an instructed device of a command chain, the device comprising: an interface configured for receiving a command signal comprising the command; wherein the device is configured for accessing/using contextual information indicating a context of the command chain and for generating a setting of the device from the command based on the contextual information; wherein the setting is associated with an operation of the device; wherein the device is configured for implementing and/or executing the setting.

Another embodiment may have a system comprising an inventive device as an instructing device; and an inventive device as an instructed device.

Another embodiment may have a method for operating a system having a command chain comprising at least one instructing device and an instructed device, the method comprising: determining a target behaviour of the instructed device and generating an instruction that indicates the target behaviour; preparing, at the instructing device, the instruction using a contextual information indicating a context of the command chain and generating a command for the instructed device based on the contextual information and as an incomplete command that misses information with respect to a complete command; transmitting the command to the instructed device; and deriving, at the instructed device, a setting for the instructed device from the command by deriving missing information in the incomplete command by use of the contextual information; and applying the setting at the instructed device.

Another embodiment may have a non-transitory digital storage medium having a computer program stored thereon to perform the method for operating a system having a command chain comprising at least one instructing device and an instructed device, the method comprising: determining a target behaviour of the instructed device and generating an instruction that indicates the target behaviour; preparing, at the instructing device, the instruction using a contextual information indicating a context of the command chain and generating a command for the instructed device based on the contextual information and as an incomplete command that misses information with respect to a complete command; transmitting the command to the instructed device; and deriving, at the instructed device, a setting for the instructed device from the command by deriving missing information in the incomplete command by use of the contextual information; and applying the setting at the instructed device, when said computer program is run by a computer.

According to an embodiment, a device, e.g., an instructing device, is configured for transmitting a command signal to an instructed device forming a command chain with the instructing device. The device comprises an interface configured for transmitting the command signal and a control unit configured for providing an instruction signal comprising an instruction associated to a target behavior of the instructed device. The device is configured for accessing and/or using contextual information indicating a context of the command chain and for generating a command from the instruction based on the contextual information. The command is associated with an operation of the instructed device. Alternatively or in addition, the device is adapted to provide contextual information indicating a context of the command chain for interpretation of a command belonging to the command chain. The device is configured for transmitting the command signal comprising the command using the interface. That is, as a part of the command chain, the device may provide for a command based on the instructions, the command derived from the instructions by use of the contextual information. The device, however, may also be outside the command chain or not a part thereof, which may allow to provide contextual information to another device being part of a command chain. Using the contextual information may allow to have a low amount of information to be transmitted with the command signal, e.g., based on an assumption which information and/or interpretation and/or contextual information is present at the instructing device. Alternatively or in addition, the device is possibly not required to know the specific details of the command interpretation at the instructed device, but can focus on the targeted behaviour, i.e., a goal that is to be achieved, which provides for a high interoperability of devices of, e.g., different manufacturers.

According to an embodiment, a device is configured for operating based on a received command as an instructed device of a command chain. The device comprises an interface configured for receiving a command signal comprising the command. The device is configured for accessing/using contextual information indicating a context of the command chain and for generating a setting of the device from the command based on the contextual information. The setting is associated with an operation of the device. The device is configured for implementing and/or executing the settings. The contextual information may be provided by the instructed device or a different entity. This allows to implement commands and/or instructions even if those commands do not fit or are not in accordance with the requested settings or structure of the device. Based on the contextual information, the device may interpret what the target behind the received commands is, so as to operate accordingly.

According to an embodiment, a system comprises an instructed device and an instructed device.

Further embodiments relate to methods for operating such devices and/or systems. Further embodiments relate to a computer program product such as a computer readable digital storage medium having store thereon a computer program.

### BRIEF DESCRIPTION OF THE DRAWINGS

Embodiments of the present invention will be detailed subsequently referring to the appended drawings, in which:

FIG. 1 shows a schematical illustration of a classical closed-loop system

FIG. 2 shows a schematical block diagram of an open-loop control system;

FIG. 3 shows a schematical block diagram of a control system having a feedback path;

FIG. 4 shows a schematical block diagram of a closed-loop control system showing external influences;

FIG. 5 shows a simplified system comprising of two function blocks; a controller and a system;

FIG. 6 shows a schematic block diagram relating to contextual information used in embodiments;

FIG. 7 shows a schematic block diagram relating to additional information and contextual information used in embodiments;

FIG. 8 shows a schematic block diagram of a system according to an embodiment;

FIG. 9 shows a schematic representation of an amount of information associated with a use of contextual information together with instructions according to an embodiment

FIG. 10 shows a schematic block diagram of a system according to an embodiment comprising a command chain having a instructing device and an instructed device;

FIG. 11a shows a schematic block diagram of an abstract representation of the command chain of FIG. 10 according to an embodiment;

FIG. 11b-d show a schematic tree-representations of ambiguity related with the block diagram of FIG. 11a according to embodiments;

FIG. 12 shows a schematic block diagram of a system according to an embodiment; that comprises ambiguity processors;

FIG. 13 shows a schematic block diagram of an instructing device according to an embodiment;

FIG. 14 shows a schematic block diagram of an instructed device according to an embodiment;

FIG. 15 shows a schematic illustration of a portion of a valid setting that may be derived from a command and at the instructed device according to an embodiment;

FIG. 16 shows a schematic flow chart of a method in accordance with an embodiment;

FIG. 17 shows a schematic block diagram of a device according to an embodiment; that may operate as an instructing device and/or as an instructed device;

FIG. 18 shows a schematic block diagram of a system according to an embodiment in which the instructed device reports ambiguity to the instructing device;

FIG. 19 shows a schematic block diagram of a system according to an embodiment in which ambiguity information may be reported from the instructing device to the instructed device;

FIG. 20 shows a schematic block diagram of a system according to an embodiment comprising the devices of FIG. 13 and FIG. 14;

FIG. 21 shows a schematic block diagram of a system according to an embodiment, having two devices from which a remote radio head is an instructed device;

FIG. 22 shows a schematic block diagram of a system according to an embodiment, having two devices from which a UE an instructed device;

FIG. 23 shows a schematic block diagram of a system according to an embodiment, having three devices from which a gNB and a UE are controlled by a third party controller;

FIG. 24 shows a schematic block diagram of another system according to an embodiment, having three devices from which a gNB and a UE are controlled by a third party controller;

FIG. 25 shows a schematic block diagram of a system according to an embodiment, having four devices, therein a reconfigurable intelligent surface, RIS, illustrating possible locations of a third party controller;

FIG. 26 shows a schematic block diagram of a system similar to FIG. 25 wherein the third party controller is a dedicated device, according to an embodiment;

FIG. 27 shows a schematic block diagram of a system similar to FIG. 25 wherein also a gNB is a controlled device, according to an embodiment;

FIG. 28 shows a schematic block diagram of a system according to an embodiment, having three devices, therein a RIS controlled by a third party controller;

FIG. 29 shows a schematic block diagram of a system according to an embodiment, having a third party controller in a UE to control a gNB and a RIS;

FIG. 30 shows a schematic block diagram of a system similar to the system of FIG. 29, wherein the third party controller is located at the RIS, according to an embodiment;

FIG. 31 shows a schematic block diagram of a system similar to the system of FIG. 30 having swapped roles of an instructed device and a further instructed device according to an embodiment;

FIG. 32 shows a schematic block diagram of a system according to an embodiment, comprising a repeater connecting a gNB and a UE, the gNB forming the instructing device;

FIG. 33 shows a schematic block diagram of a system similar to the system of FIG. 32, wherein the gNB controls the repeater and a UE, according to an embodiment;

FIG. 34 shows a schematic block diagram of a system similar to the system of FIG. 32, wherein a third party controller forms a dedicated entity of the system according to an embodiment to control the repeater and the UE;

FIG. 35 shows a schematic block diagram of a system according to an embodiment, wherein the third party controller controls the gNB, the repeater and the UE;

FIG. 36 shows a schematic block diagram of a system according to an embodiment comprising swapped roles between the gNB and the UE in view of a controlled device and a further controlled device when compared to FIG. 33;

FIG. 37 shows a schematic block diagram of a system according to an embodiment, where a third party controller of a UE controls the repeater and the gNB;

FIG. 38 shows a schematic block diagram of a system according to an embodiment where a third party controller of a repeater controls the UE and the gNB;

FIG. 39 shows a schematic block diagram of a system according to an embodiment where a third party controller of a repeater controls the UE as controlled device and the gNB as further controlled device;

FIG. 40 shows a schematic block diagram of a process to be controlled;

FIG. 41 shows a schematic block diagram of an open-loop control system;

FIG. 42 shows a schematic block diagram of an closed-loop control system;

FIG. 43 a schematic block diagram of a known system having multiple inputs and multiple outputs; and

FIG. 44 shows a schematic block diagram of a known personal computer system with a printer connected to it.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Some of the embodiments described herein relate to a use of contextual information. Such contextual information may be used at an instructing device so as to derive, from instructions describing a targeted behaviour of an instructed device, respective commands. Such commands may set the targeted behaviour into a context of other parts of the system, for example, the instructing device, the instructed device or an environment of such a command chain.

Further, contextual information may be used at the instructed device so as to set their received commands into a context to interpret the meaning of the received command.

As a further option that may be implemented as an alternative or in combination with the above, the contextual information may be provided by an entity outside the command chain to at least one of the instructing device and the instructed device such that those devices may rely on contextual information being provided from outside the command chain.

Contextual information may relate to any information or context of the command chain, e.g., the instructing device and/or the instructed device.

In view of the instructing device, the contextual information may indicate or comprise information indicating at least one of a capability of the instructing device, a manufacturer of the instructing device, a type or a model of the instructing device, an operator of the instructing device, a location of the instructing device, an operation condition of the instructing device, an absolute or relative time, a geolocation, a relative location or co-location, an orientation, a set of conditions and/or a validity information.

In view of the instructed device, the contextual information may comprise or indicate at least one of a capability of the instructed device, a manufacturer of the instructed device, a type or model of the instructed device, an operator of the instructed device, a location of the instructed device, an operation condition of the instructed device, an absolute or relative time, a geolocation, a relative location or co-location, an orientation, a set of conditions and a validity of information.

According to one illustrated example, the targeted behaviour that is to be instructed by the instructing device may comprise an indication of the device or a part thereof or a beam thereof to be placed “more to the left”. The commands derived thereof may consider information about the instructed device, into which direction the device actually is orientated so as to define the orientation of “left”, e.g., with respect to the instructing device or with respect to the instructed device. That is, whether the instructed device will consider its own orientation or the orientation of the instructing device as reference might also form a part of the contextual information. Alternatively or in addition, with regard to the term “more” in “more left” the contextual information may indicate a step size implemented at the instructing device as the step size of movement may be specific, for example, for the type, the model, or the manufacturer or other operating conditions of the instructed device. Knowing or assuming such contextual information may allow to avoid to present a definition within the corresponding command signal and/or may allow to present the command signal even in absence of knowledge about the precise instruction set at the instructed device.

When referring to the target behaviour with regard to the contextual information, according to an example, an instructed device may utilize its own (internal) reference coordinate system, wherefrom the device can reference its relative orientation or position/location with respect to a reference frame/point/anchor/coordinate system.

Alternatively or additionally, an instructed device may be located in a known/given space, e.g. a room, wherein the room provides a referenceable (external) coordinate system e.g. by a feature of the room (such as a specific corner), wherefrom the device can extract/determine its orientation and/or position/location within the said room.

Provided that knowledge about such reference coordinate systems (internal and/or external) are available at the instructing device, e.g., as contextual information, the instructing device can utilize such location/position and orientation reference system(s) to relate specific commands to them. For example a command generated by the instructing device may comprise a set of angles relating to a rotation in planes relative to a coordinate system used by the instructed device (internal and/or external).

As yet a further example, the external coordinate system can be represented globally by e.g. converting into an even larger coordinate reference system e.g. geographic coordinate system, GCS, or planetary coordinate system, PCS, where the command can be related to.

Furthermore, context or knowledge about the shared reference system or the capability to convert from one coordinate system to another and/or the coordinate system the command is referring/related to, has to be exchanged as part of the contextual information between the instructed and/or the instructing device.

In view of the problems related to known systems, the inventors have identified the need for complex tasking to be made with a controller (or commander). This may use a standardized interface that requires little or no previous knowledge of the capabilities of the entity to be controlled, therefore potentially avoiding the need for a device driver. Furthermore, when used in combination with components that use some form of artificial intelligence, partial autonomy is possible.

In this context, the inventors have identified advantages provided by replacing system-specific and device-specific instructions used at the controller. The specific instructions and instruction sets may be replaced with command sets that use contextual information provided by the controller and/or the system to be controlled. With this approach, the number of standardized interfaces and their supported command sets is minimized and the stability of the control loop may be supported or guaranteed by the introduction of a command-feedback mechanisms. The latter allows the device, system or process to provide contextual information (including feedback) to the controller. Such feedback may include further requests and/or provisioning of context relevant for the operation of the control loop.

The problems to be solved with embodiments described herein, which are summarized in the form of objectives to be achieved, are:
reduced signalling overhead—shorter commands and shorter command sets require less signal bandwidth and shorter payload lengths;
reduced latency—shorter commands can be processed quicker and acted upon faster than longer command strings;
open standards—supported by the availability of contextual information (from both the system controller and the system or process to be controlled) a command parser should be able to interpret the commands it receives from a commander. This means that the commander does not need to know the specific details of the command parser's command set since the commander is also supported with the available contextual information;
forward compatibility—through the exchange of contextual information and the availability of a minimum or reduced command set, devices introduced into a wireless communication at some time in the future can be integrated with existing equipment through the use of contextual commands.

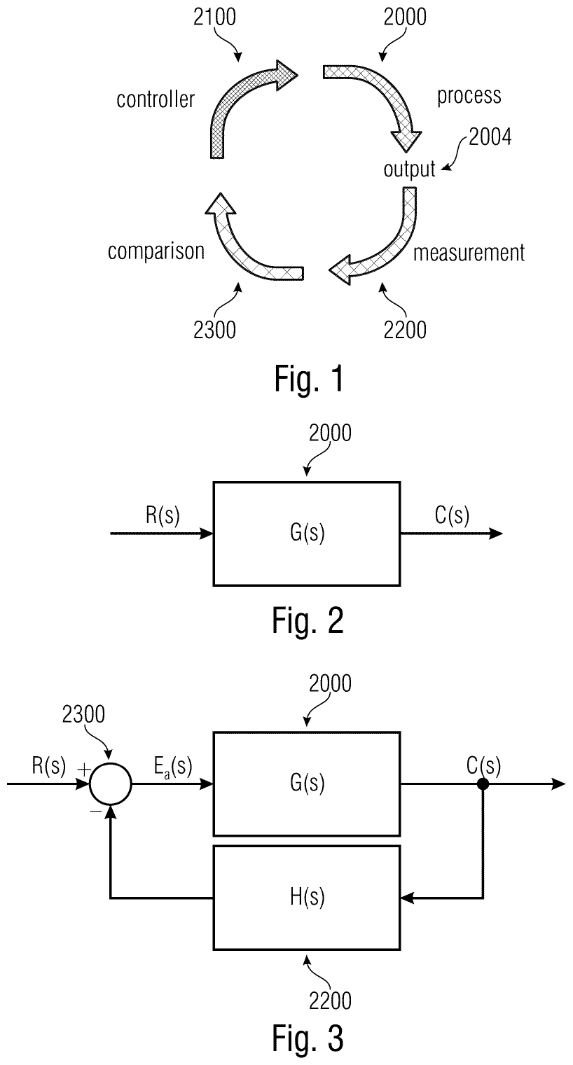

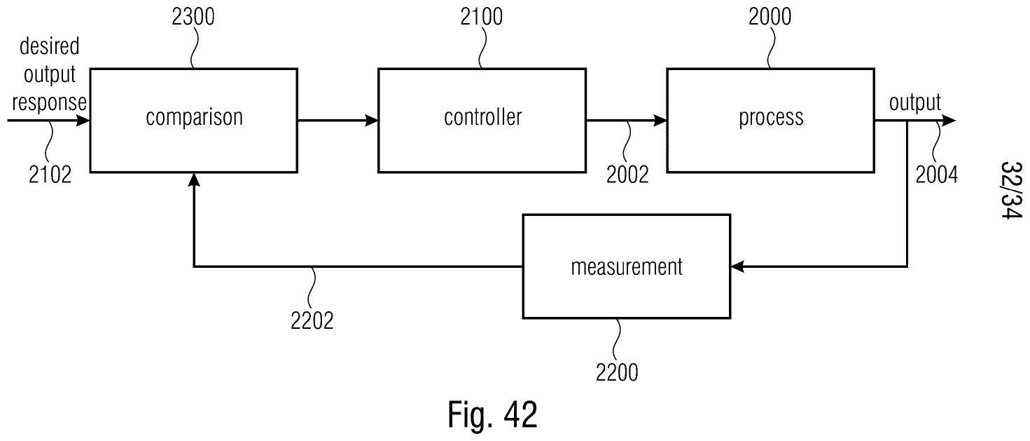

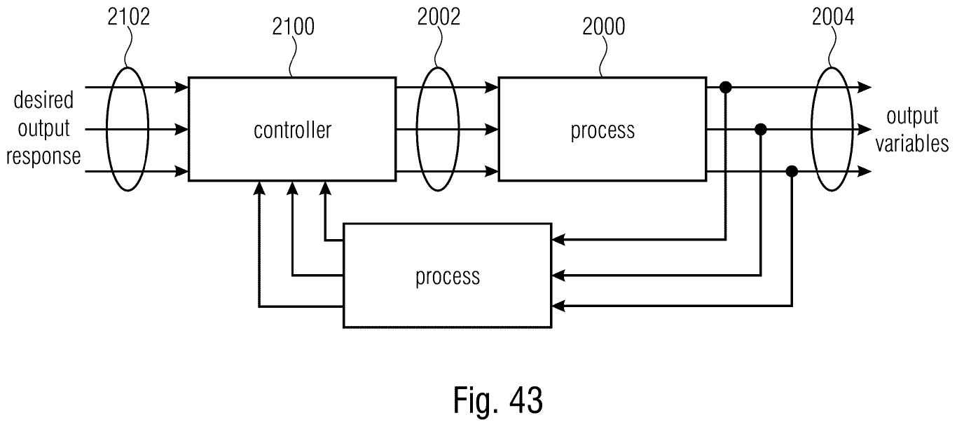

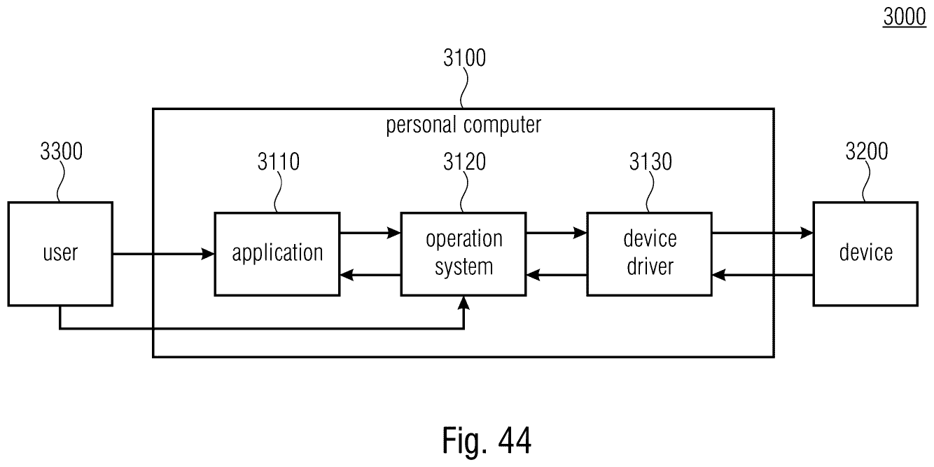

Embodiments can be on the one hand likened to a closed-loop system while on the other hand, confused with same, it is useful to explain the similarities and differences. To this end, FIG. 1 illustrates a classical closed-loop system in which a Controller such as controller 2100 is used to control a Process such as process 2000—for example, the heating of water contained in a tank used for washing and bathing in the home for which the water should be neither too cold nor too hot. The Output 2102 of the Process 2000 can be determined through Measurement 2200 whereafter the result obtained can be assessed through Comparison 2300 with the temperature setting of the Controller 2100. A similar concept is described in connection with FIG. 42.

### Closed-Loop and Open-Loop Systems

In a simple domestic heating system, the Controller is likely to either turn the heating on (fully) or to turn the heating off (fully). Starting with cold water, the Controller 2100 will ensure that heat is provided to the Process 2000 so that the water temperature increases since the measured Output 2004 of the Process 2000, when compared to the required or wanted temperature (the set point), will be lower. The Controller 2100 continues to ensure that the Process 2000 is provided with heat until the measured Output 2004 is equal to or greater than the set point. More sophisticated heating systems might use a proportional controller or those that also combine integral and/or differential comparisons.

Although the closed-loop control system described above is by definition neither an instruction system nor a command system, it relies on a feedback mechanism that, in one sense, provides contextual information relating to the output of the process.

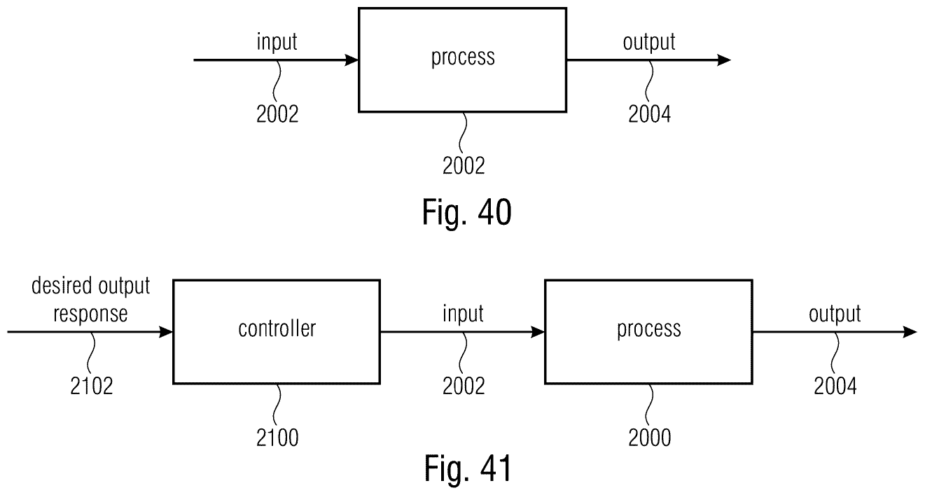

In contrast to the above, the open-loop control system illustrated in FIG. 2, see also FIG. 40 does not show any form of feedback whereas FIG. 3 does; however neither of the two figures show external influences. Process 2000 represented by its example transfer function G(s) receives input R(s) similar to input 2002 to provide for output C(s) similar to output 2004. The closed-loop system of FIG. 3 provides, by comparison 2300 an error signal Ea(s) as input for process 2000 based on the measurement 2200 indicated by H(s).

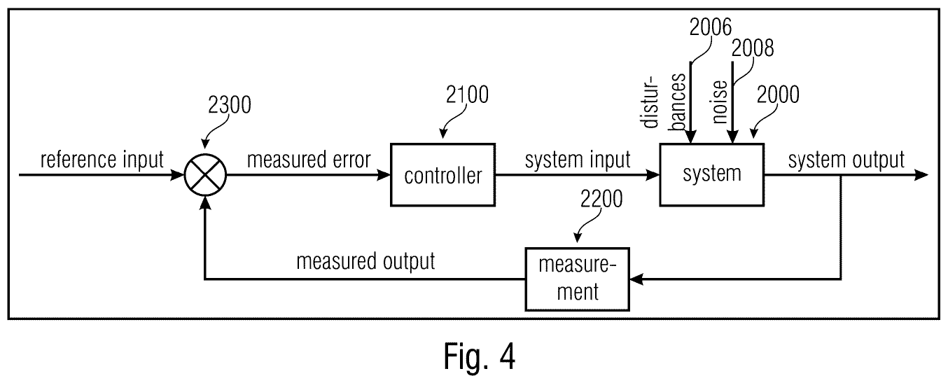

For completeness, FIG. 4 illustrating a closed-loop control system showing external influences such as disturbances and noise is affected by external influences—factors that may affect the output of the process or the system—which are labelled as Disturbances 2006 and Noise 2008. Such information is not made directly made available to the controller; it is only aware of the system output and cannot determine if it has been affected by external influences.

Having explained the principle of a closed-loop control system, the concept of a contextual command system will be introduced and, as promised earlier, the similarities and differences of the two systems will be explained.

### Command System

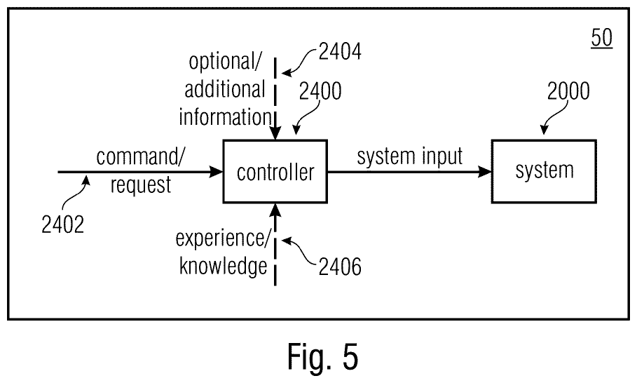

FIG. 5 depicts a simplified system 500 comprising of two function blocks; a controller 2400 and a system 2000. In the example open-loop control system the controller 2400 is equipped to process commands or requests 2402 together with optional or additional information 2404 and knowledge or experience 2406. The latter can be considered as a priori information. Whereas the system 2000 has only one connection—the system input—the controller 2400 is shown to have up to, e.g., three inputs—the obligatory command or request input 2402 and two optional inputs; one labelled as optional or additional information 2404 and the other as experience or knowledge 2406. The arrangement of the blocks, their interconnections and their optional inputs, is intended to illustrate the manner in which a command or a request is processed by a controller in order to provide an input to a system that is to be controlled or commanded. The process of control is thus comprised of taking the input command or input request 2402 and processing it—with or without additional information 2404, experience or knowledge 2406—such that the input is translated, parsed or otherwise converted into a system input which is understood by the system to be commanded.

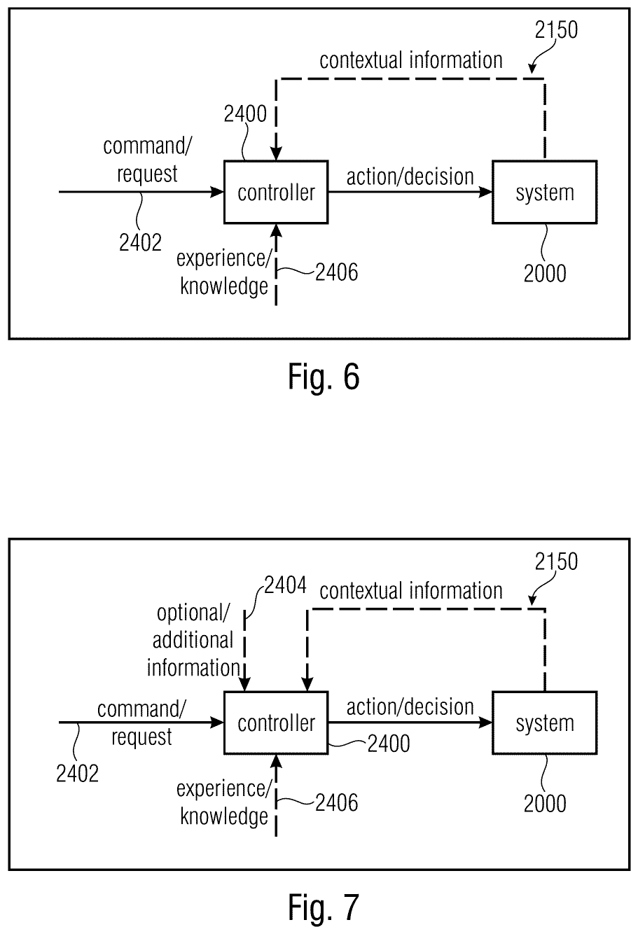

When the optional or additional information 2404 described in connexion with FIG. 5 is provided by the system 2000 itself, as is shown in FIG. 6, the structure and arrangement of connections can be compared with the closed-loop system discussed earlier (see for example FIG. 4). A control system in which the controller 2400 is equipped to process commands or requests 2402, a priori experience or knowledge 2406 and contextual information 2150. The latter can be any combination of a priori and post priori information.

It is important to note that the contextual information 2150 provided by the system in FIG. 6 is not necessarily an observation of the output of the system 2000 and could indeed represent any system state, configuration, capability, condition, availability, request and so on.

FIG. 7 shows a further arrangement in which the controller 2400 is provided with contextual information 2150 from the system 2000 and with optional or additional information 2404 from elsewhere. In the shown control system the controller is equipped to process commands or requests, a priori experience or knowledge, optional or additional information and contextual information. The latter two types of information can be any combination of a priori and post priori information.

In a linguistic example, the first exchange of contextual information might be provided by the shopkeeper of a tourist shop when asking a customer, “English, French, German?” Based on the response of the tourist, the shopkeeper can then ask “How can I help you?” in the appropriate language. Alternatively, the tourist might provide the first exchange of contextual information by asking the shopkeeper, “Mówisz po polsku?” [“Do you speak Polish?”]. Even if the shopkeeper does not speak Polish, it is likely from the context of the question—it being the first question—that they will understand they are being asked if they speak a language which is foreign to them and might thus respond with a smile and the question “Do you speak English?”. When the tourist then replies affirmatively, the conversation can begin and information can be changed. In these examples, the initiation has commenced by either the first or the second device.

### Instruction Context and System Context

The entities that comprise the elements of a modern wireless communication system (WCS) or wireless communication network (WCN) may be configurable, either directly or indirectly, by other entities that form part of the same system or network. For example, a base station might (directly) configure a user equipment device to set its output power to a certain level via a command sent over the control plane. Similarly, a user equipment device might provide the base station with information that (indirectly) causes the base station to adapt its transmission and/or reception and which might further result in the base station configuring the user equipment accordingly.

Information which is exchanged or transferred between the entities of a WCS or a WCN might therefore result in the setting of operational parameters, configurations and the such like, either directly or indirectly. In certain circumstances, information could also be exchanged between multiple wireless communication systems or networks in order to, for example, take measures to reduce the interference experienced in one or more of the systems or networks, to share the allocation of the available electromagnetic spectrum or to coordinate handoffs.

The type of information exchanged or transferred can include a variety of sorts not limited to include instructions, commands, requests, messages, signals, reports, measurements, errors, warnings, estimations, parameters and so on. As explained in connection with the control systems and command systems, there is a clear need to reduce the signalling overhead associated with such an exchange or transfer of information and in this disclosure, the inventors propose a technical solution which makes use of contextual information associated with an instruction and contextual information associate with the system.

Contextual information might be obtained by default (available to everyone), upon request (available on demand) or according to a defined level of privilege (authority-level).

Embodiments described herein relate to instructing an instructed device with an instructing device. Embodiments described herein present aspects of such a command chain that are directed to contextual information on the one hand to ambiguity arising by transferring or using instructions that might, at least in some embodiments, provide for an abstract instruction or targeted behavior when compared to specific settings to be implemented at the instructed device. Embodiments thus also relate to solve issues arising from ambiguity.

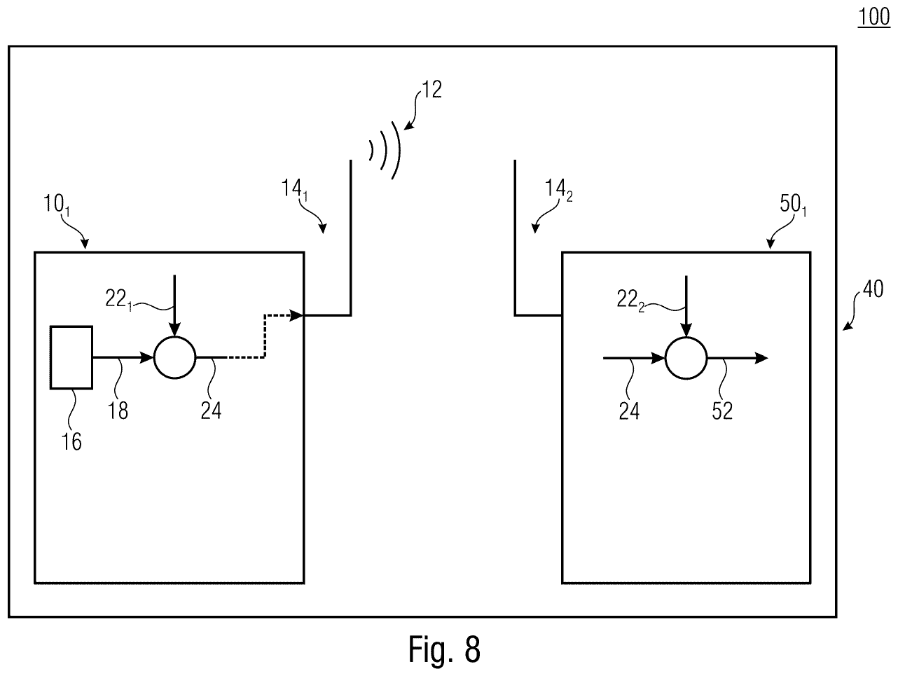

FIG. 8 shows a schematic block diagram of a system 100 according to an embodiment. System 100 comprises devices 10₁ and 50₁. Device 10₁ may be referred to as an instructing device as being adapted to transmit a command signal 12, directly or indirectly to device 50₁, which is referred to as an instructed device. Instructing device 10₁ instructing the instructed device 50₁ by use of the command signal 12 may form at least a part of a command chain 40. Device 10₁ comprises an interface 141 for transmitting and optionally for receiving signals, in particular for transmitting the command signal 12. Interface 141 may be a wired and/or wireless interface. For example, the interface 141 may comprise one or more antennas, optionally adapted to provide for MIMO functionalities, such as beam forming. The embodiments described herein are, however, not limited to the fields of wireless communications as the benefits described herein may be obtained, without limitation, by use of wired and/or optical communications.

The device 10₁ comprises a control unit 16 configured for providing an instruction signal 18 comprising an instruction associated to a target behaviour of the instructed device 50₁. One understanding of the term instructions is that it is a high-level descriptor of the wanted system behaviour of the instructed device, possibly in an abstract formulation, e.g., reduce or avoid interference, reduce or avoid interference for a specific terminal, at a specific location or the like. The instructions may, thus, formulate some sort of task, wherein it is possible but not necessary that the instructions define the specific steps to obtain or achieve the indicated goal, i.e., how the system behaviour is finally obtained.

The device 10₁ is configured for accessing or using contextual information 221 indicating a context of the command chain 40. The device 10₁ generates a command 24 from the instruction contained in the instruction signal 18 based on the contextual information 221. The command 24 is associated with an operation of the instructed device 50₁.

The instructed device 50₁ may receive the command signal 12 or a forwarded version thereof. For receiving such a signal, the device 50₁ may comprise an interface 142, e.g., a wired or wireless interface. It is to be noted that, of course, the command signal 12 being transmitted as a wireless signal may also be received as a wireless signal at the instructed device 50₁. However, especially by use of a relay or other forwarding nodes, a conversion may be obtained so as to provide a wired signal to the instructed device 50₁ based on a wireless signal transmitted by the instructing device 10₁ or vice versa. Alternatively or in addition, a frequency band, a modulation scheme or the like may be adapted without limitation. The device 50₁ may receive the command 24 by receiving a command signal carrying the command 24. The instructed device 50₁ is configured for accessing and/or using contextual information 222 indicating a context of the command chain 40. The device 50₁ generates a setting 52 of the device 50₁ from the command 24 based on the contextual information 221. The setting 52 is associated with an operation of the device 50₁. The device 50₁ is further configured for implementing and/or executing the setting.

The contextual information 221 may be accessible for the instructing device 10₁ at least partly at an internal or external data storage. In a similar way, the contextual information 222 may be accessible for the instructed device 50₁ at least partly at an internal or external data storage.

By implementing and/or executing the setting 52, the device 50₁ at least tries to follow the instructions 18 although they are possibly formulated in an abstract manner. This allows for a high interoperability as the device 10₁ may be unaware of the requirements of the settings 52 as would be required, for example, when using a sort of device driver or the like.

Contextual information 221 accessed by the instructing device 10₁ and contextual information 222 accessed and/or used by the instructed device 50₁ may be same or equal or may differ one from another. The contextual information 221 and 222 may differ from one another, for example, they may relate to different parameters of the context of the command chain 40. For example, this may relate to having access only to local information at least at one device 10₁ or 50₁ such that, for example, each device only knows its own position and/or only one or both devices knows the position of both devices or a target of a beam or the like. Alternatively or in addition, same parameters may be contained in the contextual information 221 and 222 but may differ, for example, in view of a resolution or preciseness, e.g., based on sensors used or services provided. According to an embodiment, the contextual information 221 and 222 may be from a same data source, e.g., obtained from a common central or decentral data storage. Alternatively, there may be obtained from different data sources, e.g., being obtained from local or decentralized data storages.

Another way of differing contextual information may be obtained by having different data sets or different contextual information 221 and 222 that are at least partially different from one another as indicated for using different parameters. As an alternative, the contextual information 221 and 222 may be coincident or identical. Coincident may indicate, for example, that the information itself differs such as when indicating a specific temperature once in Celsius or once in kelvin or Fahrenheit, however, the meaning of those values is same. Based thereon, the different information may be interpreted in a similar, same or identical way. This might also occur, by way of non-limiting example, when having different resolution or granularity of information that possibly exceeds a required preciseness. For example, when requiring a positioning within meters, a specific position having a granularity of millimeters may still be considered as being same or equal or identical in a case where two different positions deviate one from another by several milometers. According to embodiments, the system 100 may comprise a contextual information provider such as a sensor, a reporting node, a measurement, logging and reporting device, MLRD, a watchdog, a regulator or the like, that is adapted to provide contextual information for the instructed device 50₁ and/or for the instructing device 10₁. Such a service provider may be arranged outside the command chain, i.e., not forming part thereof.

According to an embodiment, the device 10₁ may, alternatively or instead to accessing the contextual information 221 for generating the command 24 and to transmit the command signal, the adapted to provide the contextual information indicating the context of the command chain for interpretation of a command belonging to the command chain, e.g., as additional information to be accessed by the instructed device 50₁ or the like. That is, the device 10₁ may also form a contextual information provider inside or outside the command chain 40.

According to an embodiment, the contextual information 221 and the contextual information 222 may differ one from another in view of at least one considered parameter and/or in view of a value of a same parameter. For example, a relative direction related to a position of an object in space may differ from different viewpoints whilst having a same or corresponding meaning.

According to an embodiment, the contextual information 221 may be restricted to a first information domain. This may relate, for example, to a restriction based on a de-location, based on an authorization accessing information, to a sensor position or the like. The contextual information 222 may be restricted to a second information domain, whilst the first information domain and the second information domain may partially overlap or partially exclusive or also disjoint. This does not exclude to have overlapping or identical contextual information 221 and 222.

According to an embodiment, the first information domain may be associated with a domain of the instructing device 10₁, a domain of a control unit thereof and/or a domain of a command unit of the instructing device. Alternatively or in addition, the second information domain may be associated with a domain of the instructed device 50₁, a domain of a command parser unit of the instructed device and/or a domain of a system or process of the instructed device 50₁.

With regard to the obtained possibilities for having a high interoperability, the instructing device 10₁ may be a 3^{rd} party controller, 3PC, configured for controlling the instructed device 50₁.

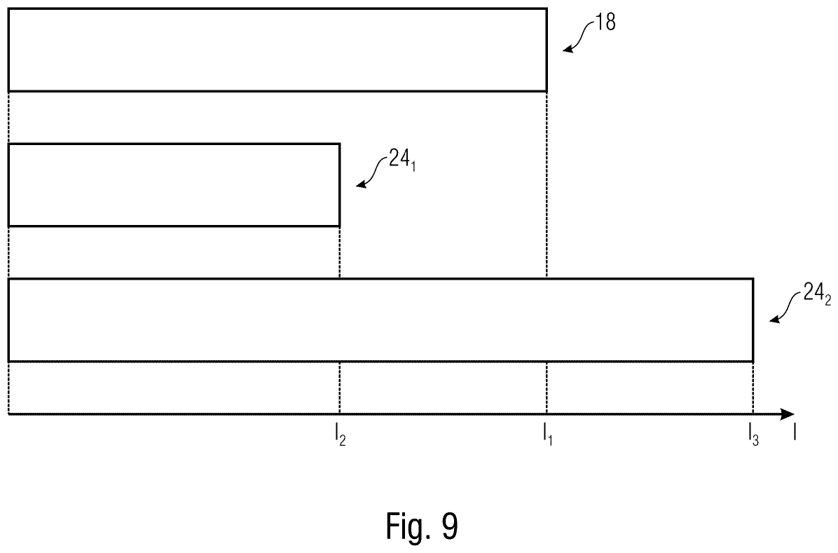

FIG. 9 shows a schematic representation of an amount of information I, e.g., a number of bits, a number to bites, a number of symbols or the like to illustrate advantages and/or effects of using contextual information together with instructions 18. For example, instructions 18 may comprise a first amount of information I₁. By use of the contextual information 221, the amount of information required in the command 241 may be reduced when compared to the amount of information 11. For example, by having knowledge that the instructed device 50₁ will interpret a missing parameter with a predefined value and that the predefined value leads to sufficient or satisfying results, the availability of such contextual information may allow to avoid transmitting the parameter or to transmit only a necessary granularity of information related hereto by expecting the instructed device to substitute missing parts with the correct values. This may allow to reduce overheads and to transmit signals causing less traffic when compared to transmitting the instructions. On the other hand and as shown for command 24₂, the amount of information may also be increased which may seem to contradict an aim to avoid overhead. However, the contextual information 22₁ may indicate that the instruction is possibly, likely or even sure insufficient and will cause a re-transmit or other failures such that by adding additional information such a re-transmit may be avoided.

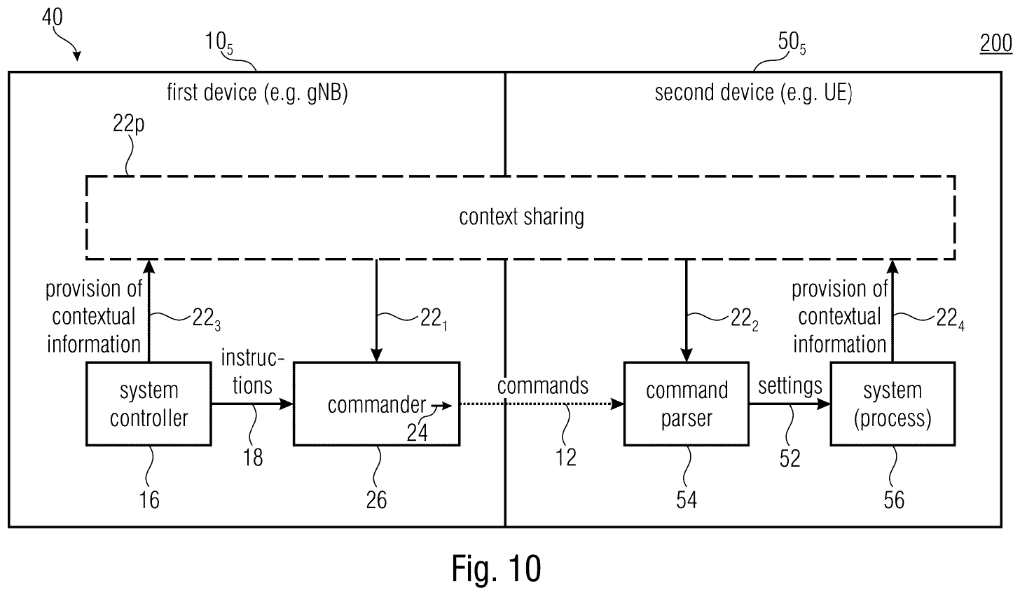

FIG. 10 shows a schematic block diagram of a system 200 according to an embodiment. System 200 comprises the command chain 40 having instructing device 10₂ and instructed device 50₂ that may be in accordance with instructing device 10₁ and instructed device 50₁, respectively. By way of non-limiting example, the instructing device 10₂ may be referred to as a first base station and may implement at least a part of a base station, gNB. The instructed device 50₂ may be referred to as second device and may form a UE, a IoT-device, or an instructed base station or a different entity, e.g., a reconfigurable intelligent surface, RIS.

The instructing device 10₂ comprising a base station and the instructed device 50₁ being one of the above mentioned forms an example implementation that does not limit the scope of the described embodiments. Each of the instructed device and the instructing device may be implemented as a discrete device or an entity of the network but may also be implemented as a distributed entity. Such entities may be referred to as the network or a part thereof. The instructing device 10₂ and the instructed device 50₁ may form a pair of devices or entities, both entities can be or at least include pairs of:
BS—UE
UE—UE
BS—BS
BS—any other network entity
UE—any other network entity
UE—RIS
UE—repeater
Network—IoT device e.g. car, UAV, robot, AGV (automatic guided vehicle)
3rd party controller—a network component
3rd party controller—a network entity
UE—access point, AP, (e.g., WiFi AP)
Inter radio access control technology control, RAT control, (e.g., a member of on WCS controlling an entity or the behaviour of another WCS.

The transmission of information such as instructions, commands and/or feedback is not required to rely on a direct signalling between exactly two devices but may make use of one or more intermediate components such as a relay, a RIS, a satellite or combinations thereof. This may result in a command chain having three or more devices or entities, e.g., comprising:
BS—relay—UE
BS—RIS—UE
UE—RIS—UE
UE—satellite—UE
Ground station-satellite-UE

The entities may use unilateral and/or bilateral communication in the one or other direction.

The instructing device 10₂ may comprise a command unit 26 configured for accessing and/or using the contextual information 22₁ and for generating the command based on the instructions 18 received from the control unit 16 forming a system controller. Optionally, the control unit 16 or a different entity of the device 10₂ may provide contextual information 223 to a pool 22, of context information. Although the pool 22ₚ is shown so as to reach between devices 10₂ and 50₂, each of the devices 10₂ and 50₂ may have its own source and/or access to a same or different kind of contextual information 22.

The command unit 26 may be implemented, for example, as a discrete or individual entity of the instructing device 10₂, but may also form a functional block, e.g., within the control unit 16, e.g., in a common processor unit, processor array, calculation unit or the like.

The instructed device 50₂ may comprise a command parser unit 54 that may form a dedicated or common part with a system, process or processor 56 of the instructed device 50₂. The command parser unit 54 is adapted to access/use the contextual information 222 to derive or generate the setting 52 of the device 50₂.

As described in connection with the instructing device 10₂, also the instructed device 50₂, e.g., by use of the command parser unit 54 and/or the system 56, may provide contextual information 22₄, e.g., for refining, enriching or updating contextual information in the context information pool 22ₚ.

For example, the instructed device 10₂ may be adapted for providing contextual information 223 associated with the command chain 40 and/or for a different command chain to which the device 10₂ does not belong. However, a level of interference, a temperature, a position or other parameters may be of relevance for a different command chain such that device 10₂ and/or device 50₂ may provide contextual information 22₃ and/or 22₄ not only for their own, chain 40, but also for other command chains. Such a provision of contextual information 22₃ and/or 22₄ associated with a different command chain may be provided upon request, based on a triggering event, within a regular interval or the like. The triggering event may be internal or external, e.g., the device 10₂, 50₂ respectively may recognize such an event to provide the information.

The contextual information 22₁-22₄ may contain a generic information that is generic for a type of instruction, a type of at least a component of the device, a type of at least a component of the instructed device and a description of the process at the instructed device 50₂.

As shown, for example, in connection with FIG. 9, one of the possible purposes of using contextual information is to substitute information expected to be known at the instructed device. The instructing device 10₂, e.g., the command unit or commander 26, may be configured for deriving, from the contextual information 22₁, expectedly known information that is expected to be known at the instructed device 50₁/50₂ and to remove or substitute the expectedly known information from the command 24.

Not only by substituting parts of information, but also by enabling system 100 and/or 200 to provide instructions on a high-level, there may arise ambiguities at different instances in the system.

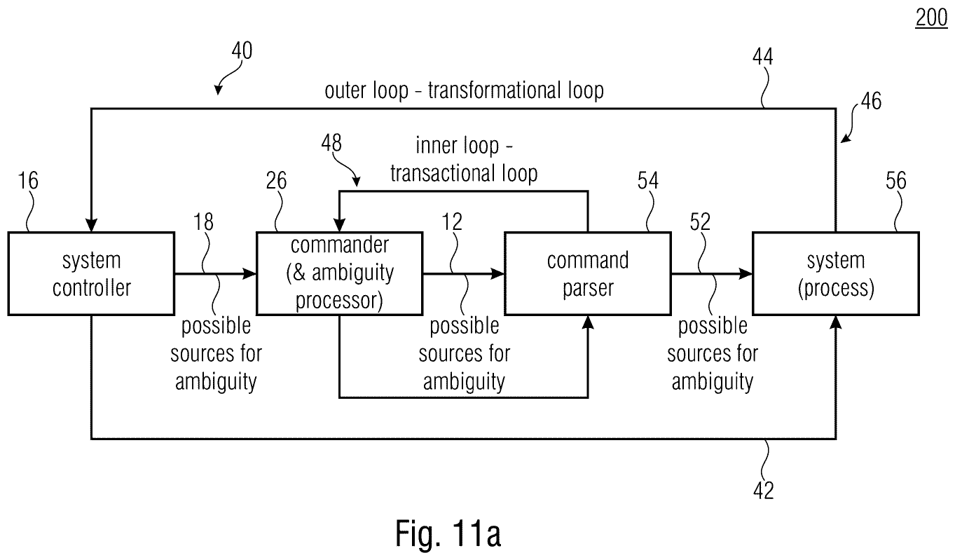

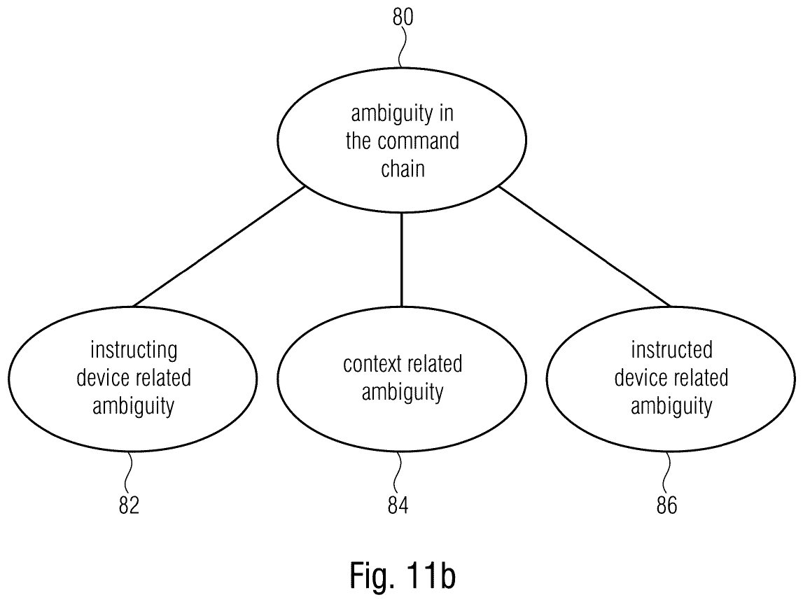

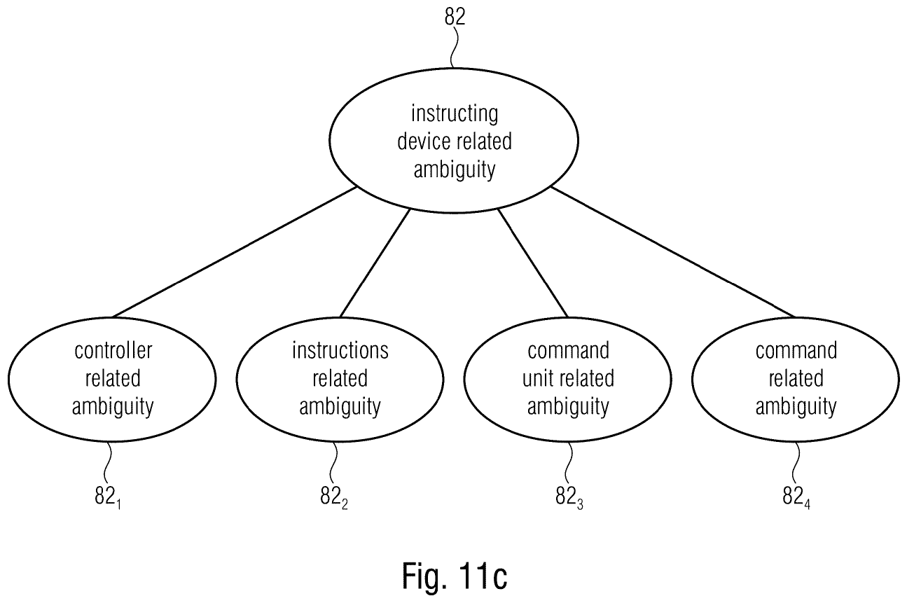

To explain this issue in more detail, reference is made to FIG. 11a showing a schematic block diagram of the system 200 presented in FIG. 10.

System 200 is shown as a chain starting with the control unit 16 providing an instruction 18 to the command unit 26 (optionally including an ambiguity processor) to obtain the command signal 12 carrying the command 24 to be received by the command parser unit 54 to generate the setting 52 for the system/process 56. The control unit 16 aims, with the instructions 18, to cause a target behavior of the system or process 56. Thereby, an intended control 42 of the system/process 56 is implemented and causes an implemented behavior of the system/process 56 that may be measured, reported, or otherwise recognized to form some sort of feedback 44 of the command chain 40, the feedback 44 informing the control unit 16 about the result of the instructions 18. The intended control 42 may be considered to form an outer loop or transformational loop together with the feedback 44.

Alternatively or in addition, between the command unit 26 and the command parser unit 54 an inner loop, a so-called transactional loop may be arranged or present. When referring again to FIG. 10, the command unit 26 and the command parser unit 54 both access/use contextual information and, thus, try to interpret the instruction in view of the context of the command chain on the one hand and to form the setting 52 in view of the context.

Whilst the transformational loop 46 is related to a target, i.e., indicates what is to be achieved, the transactional loop 48 may relate to a specific action, i.e., what to do.

Each of the items presented, i.e., the control unit 16, the command unit 26, the command parser unit 54 and/or the system/process 56 as well as their inputs or outputs, e.g., the instruction 18, the command 24 in the command signal 12 and/or the setting 52 may form a possible source for ambiguity. In one example, an instruction to indicate a movement of the device 50₂, a part of thereof, a beam thereof, or the like, “to the left” may be ambiguous with regard to which kind of left, e.g., from an orientation of the instructing device 10₂ or from the instructed device 50₂. The ambiguity and the handling thereof, thus, forms part of advantageous embodiments described herein.

According to an embodiment, the control unit 16 may be configured for an evaluation whether a behavior of the instructed device, in particular, the system/process 56, corresponds to the target behavior. For the evaluation, the control unit 16 may use at least one of a measurement report reporting about a measurement associated with the behavior, e.g., directly or indirectly, an updated contextual information being updated based on the behavior and a feedback received from the instructed device. In view of a direct or indirect measurement of the behavior, a requested change of a generated beam being formed with the instructed device may be measured indirectly, e.g., when recognizing additional multi path components available at the instructing device or a different entity. A direct measurement may be available when directly monitoring the behavior of the system, for example, when instructing the instructed device to increase a transmission power or the like. An updated contextual information that is updated based on the behavior may relate, for example, in an updated position, relative location, orientation of the instructed device, provided as additional contextual information 22₄ and accessible for the control unit 16 and/or a different entity of the instructing device 10₃.

The control unit 16 may be configured, within the evaluation, for comparing the behavior of the instructed device with the target behavior and for determining a deviation between the behavior of the instructed device and the target behavior. Based thereof, the control unit 16 may provide an updated instruction with regard to the target behavior or an up [dated target behavior based on the deviation. For example, if there is still a remaining movement, e.g., of the device or of a beam, the target behavior may be updated to indicate a remaining movement. For example, in connection with the updated target behavior, the control unit may also consider that the instruction is wrongly executed, e.g., based on erroneous contextual information 22₁ and/or 22₂. In one illustrated example, a device that is instructed to implement a movement may move but into a wrong direction. Instead of further aiming a movement to a specific direction which is erroneously implemented, the target behavior may be adapted to intentionally provide an error-prone instruction/command that cancels out an error contained in the contextual information 22₁ and/or 22₂. By way of non-limiting example, if the instructions 18 tell the instructed device 18 to perform a movement to the left and if a movement to the right is detected, an updated instruction may indicate for a movement to the right whilst as a result expecting a movement to the (intentional) left.

That is, the command signal 12 may be considered as a first command signal. The instructing device may be configured for using additional contextual information provided by the instructing device itself or a different device for providing a different second command signal for a same instruction, e.g., by recognizing that the command signal 12 contains erroneous or ambiguous content. The same instruction may be converted into a different command signal having a different amount of information. Based on the additional contextual information, the instructing device may be configured for reducing an amount of information contained in the next command signal when compared to the first command signal.

According to an embodiment, the control unit 16 may be configured for correlating the deviation with the contextual information available to the instructing device and/or the instructed device and for updating the contextual information and/or considering, in the updated instruction, the deviation. That is, the control unit 16 may know or be aware of a misinterpretation at the instructed device or may consider the falsified execution as an objectively falsified instruction that is corrected by the misinterpretation or the incorrect contextual information.

FIG. 11b shows a schematic tree for explaining that an ambiguity 80 in the command chain of FIG. 11a may have its origin, at least in part, in the instructing device so as to lead to an instructing device related ambiguity 82. Alternatively or in addition, the ambiguity may have at least a part of its origin in the contextual information so as to lead to a context related ambiguity 84. Alternatively or in addition, at least a part of the ambiguity may have its origin in the instructed device so as to provide for instructed device related ambiguity 86.

Whilst the context related ambiguity 84 may be caused, at least in parts, by having contradicting information for different devices, information in different degrees of resolution, preciseness, or actuality and/or age, the instructing device related ambiguity 82 and the instructed device related ambiguity 86 are described in more detail in connection with FIG. 11c, FIG. 11d respectively.

As shown in FIG. 11c, examples for instructing device related ambiguity is controller related ambiguity 821, instructions related ambiguity 822, command unit related ambiguity 823 and/or command related ambiguity 824. One or more of those ambiguities may be present at an instance of time, wherein the amount and the present itself may vary over time.

FIG. 11d shows a schematic tree diagram for illustrating that at least a part of the instructed device related ambiguity 86 may be formed by a command related ambiguity 861 which may be same or similar but also different from the command related ambiguity 824. Alternatively or in addition, a command parser unit related ambiguity 862, a setting related ambiguity 863 and/or a system related ambiguity 864 may form at least a part of the instructed device related ambiguity.

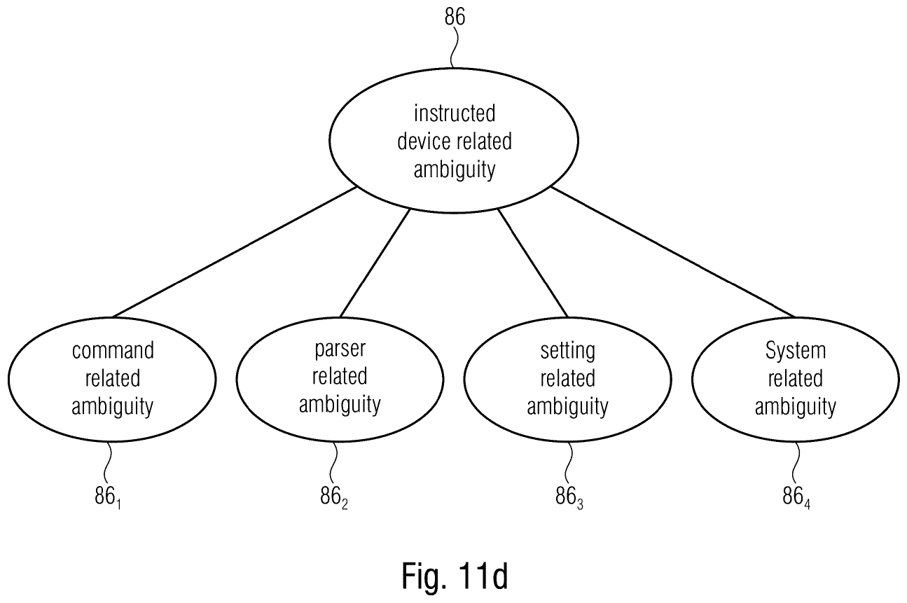

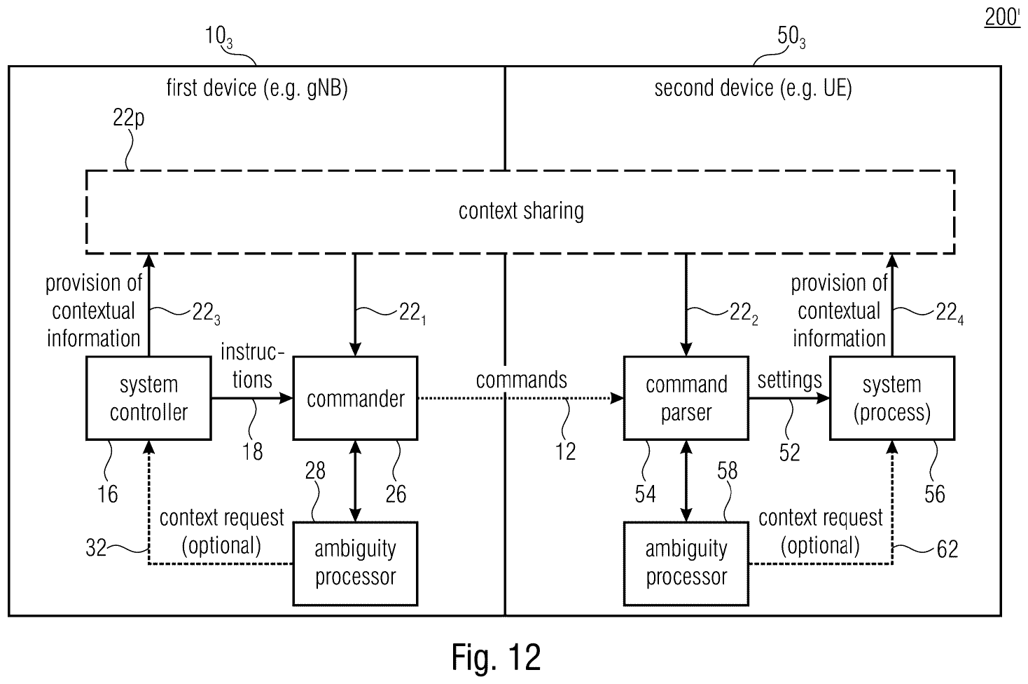

FIG. 12 shows a schematic block diagram of a system 200′ that comprises at least some of the components of system 200. An instructing device 10₃ comprises, when compared to the instructing device 10₂ an ambiguity processor 28 adapted to identify and/or handle ambiguity.

Instructed device 503 may comprise, when compared, to the instructed device 50₂ an ambiguity process 58 connected to the command parser unit 54. The ambiguity processor 28 connected to the command unit 26 and/or the ambiguity processor 58 connected to the command parser unit 54 may, in an optional implementation, form a part of the respective component, i.e., the command unit 26 (see, for example, FIG. 11a), command parser unit 54 respectively. The ambiguity processor 58 may transmit an ambiguity result 62 to the system/process 56 as described for the ambiguity result 32, e.g., to request additional contextual information.

The ambiguity processor 28 may be configured for evaluating an ambiguity of the instruction 18 with respect to the contextual information 22₁ to obtain an ambiguity result 32. The ambiguity result 32 may be provided to the control unit 16, wherein the control unit 16 may reduce the ambiguity based on the ambiguity result 32. The ambiguity result 32 may, thus, be a kind of internal feedback whether the command that may be generated by the command unit 26 is, in view of the instruction 18 on the one hand and the contextual information 22₁ on the other hand, ambiguous, unambiguous, or ambiguous within a certain tolerance range. As will be described later in more detail, the ambiguity processor 28 may, according to embodiments, receive ambiguity information provided by the instructed device 50₂ to obtain the ambiguity result 32. Thereby, not only an internal feedback is presented, but also a feedback, e.g., within the transactional loop 48 or the transformational loop 44.

Responsive to having an indication that the instruction 18 is ambiguous in view of the contextual information 22₁, the control unit 16 may provide a new instruction signal comprising a new instruction 18 associated to the target behavior. The new instruction may contain supplementary information and/or supplementary instruction when compared to the prior instruction to reduce the ambiguity. For example, in view of the example in which the target behavior is associated with a movement to the left, such supplementary information may indicate whether left refers to the instructing device 10₂, to the instructed device 503, or with regard to a specific location and/or direction. Alternatively or in addition, the control unit 16 may be configured for providing supplementary contextual information 22₃ about the device 10₃ for decreasing the ambiguity at the instructed device 503. That is, the additional contextual information 22₃ may form at least a part of the contextual information 22₂ of a later instance of time or for a further interpretation of the command in the command signal 12.

Alternatively or in addition the control unit 16 may, responsive to the ambiguity result 32, configured for controlling the device 10₃ to send a request to the instructed device 503 for providing supplementary contextual information 22₄ about the instructed device 503. That is, acknowledge that the instruction 18 is ambiguous, the instructed device 10₃ might request additional contextual information from the instructed device 503. Such a request may, as an alternative or in addition, be also transmitted to devices outside the command chain, e.g., to external observers, sensors or other network nodes.

The system 200′ or other systems described herein may comprise a centralized or a distributed memory having stored thereon the contextual information. As shown by the provision of contextual information 22₂ and/or 22₄, an instructing device or an instructed device in accordance with embodiments may be configured for providing, receiving and/or updating the contextual information in the pool 22ₚ. Further, devices outside the system or command chain may also provide, receiver, and/or update the contextual information.

Facing an ambiguous instruction 18, the control unit 16 may be configured for providing the new instruction signal so as to comprise a change in a parameter of the instruction and/or at least one additional parameter when compared to the instruction. This may allow to implement a more precise instruction that allows further information to be contained in the command of the command signal being based thereon, the instructing device 10₃, e.g., the command unit 26, may generate a new command signal containing a new command based on the new instruction and based on the contextual information 22₁ or an updated version thereof. When compared to the former command signal, the new command signal may comprise at least one of information with increased granularity, e.g., allowing for a more precise determination of a specific value, an additional data field containing an additional parameter and an additional side constraint for the target behavior. For example, instructions to avoid interference may be associated with a side constraint indicating a minimum transmission power to avoid loss of communication. On the other hand, instructions 18 indicating to communicate with a maximum allowable power may indicate, as a side constraint, which is the maximum allowed power.

From a further perspective, the command unit 26 of the instructing device 10₃ may be configured for using additional contextual information, e.g., an updated version of contextual information 22₁, e.g., updated through provision of contextual information 22₃ and/or 22₄ or of a different entity or by accessing an increased pool 22ₚ, i.e., additional contextual information provided by device 10₃ or a difference device so as to provide a new command signal 12. Based on the additional contextual information the control unit 16 may be configured for reducing an amount of information contained in the new command signal when compared to the instruction signal 18. That is, additional contextual information may allow to reduce an amount of information in the instructions or in the commands.

According to an embodiment, device 10₃, e.g., the command unit 26 thereof may be configured for accessing the contextual information 22₁ and for generating the command for the command signal 12. The ambiguity processor 28 may be configured for providing the ambiguity result 32 so as to indicate ambiguity in at least one of an input of the command unit 26, e.g., the instructions 18 and/or the contextual information 22₁ on the one hand and an output of the command unit 26, e.g., the command signal 12. The ambiguity in the input of the command unit 26 may relate to an ambiguity associated with the control unit 16, e.g., the instruction 18 itself or in view of the contextual information 22₁ and/or associated with the instruction itself. For example, the instruction may itself be ambiguous, for example, when indicating to perform power control, it may be ambiguous to which frequency band the instruction relates or which side constraints are to be applicable or the like. Further, the contextual information 22₁ may render the instructions 18 ambiguous, e.g., in view of different local coordinate systems or geolocations or the like. Alternatively or in addition to the ambiguity relating to the input of the command, the ambiguity in the output of the command unit 26 may relate to an ambiguity associated with the instruction 18 and/or associated with the command 24.

According to an embodiment, the ambiguity processor 28 may be configured for providing the ambiguity result 32, e.g., for ambiguity related to the system controller/input referred ambiguity so as to indicate at least one of
ambiguity associated with the control unit, e.g., whether the meaning such as left/right is unambiguous
ambiguity associated with a command unit
output related ambiguity associated with the command unit in view of the contextual information and the instruction
ambiguity associated with a command parser unit of the instructed device
ambiguity associated with a system or process of the instructed device
an indicator whether the instruction is understood in view of the contextual information
a probability whether the instruction is understood in view of the contextual information
an indicator whether the command is→understood/clear in view of the CI
a context refinement request indicating a request to provide supplementary contextual information about the command chain, e.g., about the instructing device and/or the instructed device and/or other influencing parameters.

According to an embodiment, the instructing device 10₁, 10₂ or 10₃ may be implemented such that the control unit and a command unit thereof are functionally arranged totally within the device 10₁, 10₂, 10₃ respectively or at most, partly as a network entity of a network comprising the instructing device.

### Instructions, Commands and Settings

With reference to the left-to-right flow of forward information (instructions, commands and settings) shown in FIG. 10, the following definitions may be noted:
Instructions are high-level descriptors of the wanted system behaviour and are sent from the system controller to the commander. The system controller and the commander may be contained functionally within the first device either uniquely or as a combination of a network entity and the first device.
Examples of instructions are not limited to include the following:
   a. Increase data rate (for given user(s)/user group(s))
   b. Reduce interference (into given cell/direction/band)
   c. Deactivate (given sector(s)/user(s))
   d. Broadcast a warning or alert
   e. Perform an end-to-end measurement (using specified resource(s))
   f. Reduce network energy consumption (within given constraints)
Commands are sent from the commander of the first device to the command parser of the second device. Commands can be relative and/or absolute strings that describe an operational parameter or unit.
Examples of commands are not limited to include the following:
   g. Request/obtain capabilities
   h. Decrease/increase power
   i. Decrease/increase power by X dB
   j. Set power to minimum/maximum
   k. Set power step to X dB
   I. Set carrier to channel X
   m. Set carrier frequency to X Hz
   n. Increase modulation and coding scheme (MCS) class
   o. Move beam left/right/up/down
   p. Move second beam left/right/up/down
   q. Move first beam left/right/up/down by X degrees
Settings are sent within the second device from the command parser to the system or process to be controlled. Settings can be comprised of configuration(s) as single values or as sequences of values. It is expected that settings will be implementation specific.
Examples of settings include:
   r. control of a phase shifter that forms part of an electronically-steered antenna array using a five-bit parameter setting wherein the bit pattern is sent over a four-wire Serial Peripheral Interface (SPI) bus.
   s. control of a variable gain power amplifier (VGA) that forms part of an electronically-steered antenna array using a four-bit parameter setting wherein the bit pattern is sent over a three-wire inter-integrated circuit (I2C), alternatively known as I2C or IIC, bus.
   t. control of a voltage-controlled oscillator (VCO) that forms part of a receiver wherein a control voltage in the range of 0.0-1.0 V is provided by a 16-bit digital-to-analogue (ADC) converter. The setting for the VCO is sent over a three-wire I3C bus. [Note: I3C offers some backwards compatibility to I2C.]

### Commander and Command Parser

In other words, the system of FIG. 12 is comprised of two devices, each containing a number of functional blocks, in which the first device includes a commander and the second device a command parser and illustrates a contextual command system. From left to right, instructions are converted to commands and commands are converted to settings. Each conversion may use contextual information provided by the first and second device. Additional information flow paths are also shown. When used in combination, the commander/command unit 26 and command parser unit 54 enable high-level instructions issued by the system controller to be translated into the low-level (system) settings needed to achieve the wanted system behaviour. The commander thus prepares commands which are sent to the command parser. For example, the instruction is a high-level descriptor of the system behaviour (including specific parts thereof, the system comprising the instructed device, the behaviour intended by the instructing device

For example, the instruction may be associated with at least one of:
an increase of a data rate provided by the instructed device with a data signal;
a reduction of interference generated by the instructed device;
an activation or a deactivation of at least a part of a functionality or service of the instructed device;
a broadcast provided by the instructed device, e.g., a warning or alert;
an execution of an end-to-end measurement or test;
an adaption of an antenna radiation pattern or parts of same;
an adaption of antenna gain;
an adaption of a radio parameter; and
a reduction of network energy consumption, e.g. within given constraints.

Those instructions are provided as embodiments on the one hand and for illustrating the high-level property thereof on the other hand, the latter also applicable for other unshown instructions.

A command derived from the instruction may comprise at least one of at least one of:
to request or to report capabilities of the instructed device
to decrease or increase a power of the instructed device;
to decrease or increase a power of the instructed device by a value specified in the command;
to set a power of the instructed device to a minimum or maximum value;
to set power step implemented by the instructed device to a value specified in the command;
to set a carrier used by the instructed device to a channel specified in the command;
to set a carrier frequency used by the instructed device to a frequency specified in the command;
to increase or decrease a modulation and coding scheme (MCS) class used by the instructed device;
to move a first beam generated by the instructed device along a direction;
to move a first beam generated by the instructed device along a first direction and a second beam generated by the instructed device along a second direction; or to move the first beam and the second beam along a common direction;
to move a beam generated by the instructed device along a direction by an amount specified in the command.

### Context Sharing

In order to create efficient commands—for example those that result in a reduced signalling overhead and/or latency—the commander and the command parser may be provided with contextual information from the first device and/or the second device.
Context provision: (from 1^{st} device OR from 2^{nd} device) OR (from both 1^{st} AND 2^{nd} devices)

It is important to note both the commander and or the command parser can use contextual provided by the system controller and/or the system (process). In other words, it is necessary for at least one of the devices to use the contextual information provided by itself and/or from the other device. The provision of contextual information in this manner enables the commander and command parser to implement commands with reduced overhead and reduced latency.

### Ambiguity

Both the commander and the command parser can be equipped with the means to assess and report their understanding of an instruction or command, respectively.

In the first device, the system controller issues an instruction to the commander. Depending on the context in which it was given and the context for which it was intended, the commander can assess its interpretation of the input information it has been given or, in other words, the commander's output can be quantified by determining its ambiguity. For example, an ambiguity indicator can be provided that gives:
a. Instruction acknowledged (IACK) or instruction not acknowledged (INACK). Here a Boolean or binary value is assigned to the ambiguity output or indicator, for example Boolean “true” means instruction acknowledged (fully understood) and Boolean “false” means instruction not acknowledged (not understood at all).
b. A measure of the level of ambiguity (e.g. 0%, 10%, 50%, 100%, X %). A level of ambiguity is defined, for example 0% means instruction not understood at all, 50% means that there is equal probability of the instruction having been understand either correctly or incorrectly, and 100% means that the instruction was fully understood—interim values are not excluded.
c. A context refinement request. This is produced by the commander with the purpose of obtaining further or additional contextual information from at least one of the system controller and the system or process to be controlled.

In the second device, the command parser receives a commander from the commander. Depending on the context in which it was given and the context for which it was intended, the command parser can assess its interpretation of the input information it has been given or, in other words, the command parser's output can be quantified by determining its ambiguity. For example, an ambiguity indicator can be provided that gives:
d. Command acknowledged (CACK) or command not acknowledged (CNACK). Here a Boolean or binary value is assigned to the ambiguity output or indicator, for example Boolean “true” means command acknowledged (fully understood) and Boolean “false” means command not acknowledged (not understood at all).
e. A measure of the level of ambiguity (e.g. 0%, 10%, 50%, 100%, X %). A level of ambiguity is defined, for example 0% means command not understood at all, 50% means that there is equal probability of the command having been understand either correctly or incorrectly, and 100% means that the command was fully understood—interim values are not excluded.
f. A context refinement request. This is produced by the commander parser with the purpose of obtaining further or additional contextual information from at least one of the system controller and the system or process to be controlled.

The ambiguity indicator provided by both the commander and command parser can be configured to be active, active on demand or to be provided according to some threshold, a schedule, a trigger and so on.

In a linguistic example, an interrogator will adapt the content of her cross-examination according to the responses received from the person being interrogated. During a question-and-answer session, the breadth or scope of the questioning will be modified in accordance with the answers given and the level of ambiguity assessed by the questioner.

In a second linguistic example, a father might ask his teenage daughter, “How was school today?”. The daughter, clearly not wishing to converse, responds with the single word, “Okay”. As the father would normally have expected a fuller answer—a sentence with at least three words—he composes his next question and those following in an attempt to determine what has upset his daughter. In effective, the father uses his knowledge and experience and the limited contextual information provided by his daughter.

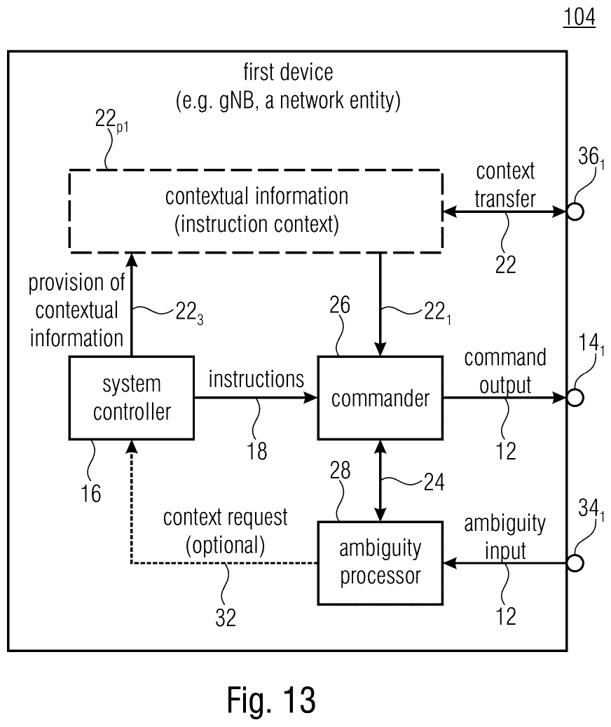

FIG. 13 shows a schematic block diagram of an instructing device 10₄ according to an embodiment. When compared, for example, to FIG. 12, the instructing device 10₃ thereof may be equipped with an additional ambiguity input or ambiguity interface 341 and/or a context interface 36₁ to exchange contextual information with other entities, e.g., the instructed device and/or other parts of the system. The ambiguity process 28 may receive, for example, the command 24 or a version derived thereof and/or contextual information 22₁.

The device 10₄ may comprise a context interface 36₁ for context transfer, i.e., a transfer of contextual information. Such a transport may directly or indirectly transfer contextual information to the instructed device. Alternatively or in addition, the instructing device 10₄ comprises an ambiguity interface 341 for receiving ambiguity information from the instructed device, e.g., as an ambiguity input.

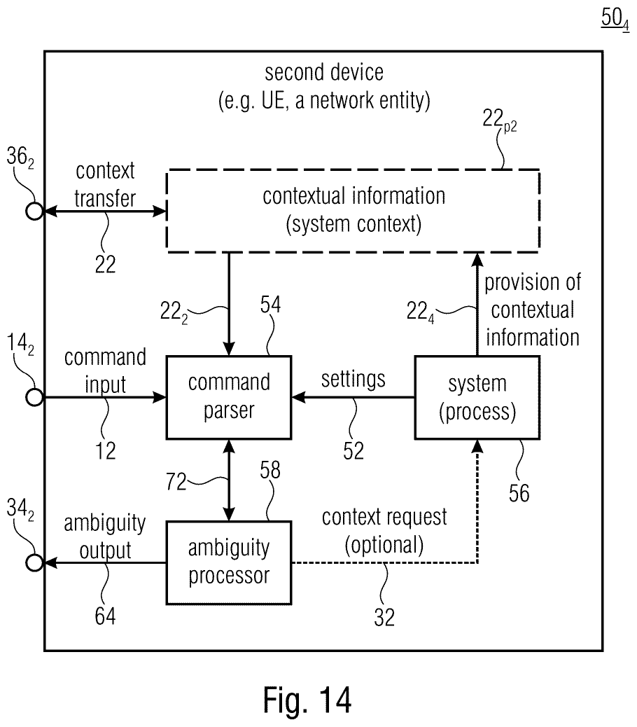

FIG. 14 shows a schematic block diagram of an instructed device 504 according to an embodiment, having, when compared to the instructed device 503, an ambiguity output 342 to provide ambiguity information 64, e.g., to the instructing device 10₄. However, a direction of transmitting ambiguity information between instructing device 10₄ and instructed device 504 may be uni-directional from device 504 to device 10₄ but may also be uni-directional from device 10₄ to device 504 or may be bi-directional.

The command parser unit 54 and the ambiguity processor 58 may exchange information, e.g., received commands, derived settings and/or determined ambiguity using command/setting-related information 72.

According to an embodiment, the instructed device comprises the ambiguity interface 342 for transmitting an ambiguity signal based on the ambiguity information 64 for providing information about a determined ambiguity.

For example, the instructed device may be configured for providing the ambiguity signal as a feedback that indicates at least one of an information identifying the device or an intended receiver of the ambiguity signal; a type of feedback provided; a validity information of the feedback, e.g., for whom the feedback was intended, how long it is valid, which part of the network is subject of the feedback, a priority such as indicating whether the feedback is important or to be considered as a side information or the like. The type of feedback may indicate, for example, an ambiguity feedback such as indicating an ambiguity of an instruction, the contextual information, the command, the setting or an ambiguity of a system behavior. Alternatively or in addition, the type of feedback may indicate a positive or a negative acknowledge feedback (ACK/NACK) e.g., acknowledging a successful or failed execution of the command, a contextual request feedback requesting additional contextual information, a system behavior feedback indicating an observed or expected or unexpected system behavior responsive to the settings and/or the command and/or a refinement request indicating a request to refine information to reduce ambiguity.

For example, in a case where the type of feedback indicates the refinement request indicating the request to refine information to reduce ambiguity, the refinement request may relate to at least one of a refinement request that allows a decision at the instructing device whether to provide for at least one of an additional contextual information, a refined command and a refined instruction, a context refinement request indicating a request to provide for an additional contextual information and a command refinement request indicating a request to provide for a refined instruction and/or a refined command.

According to an embodiment, the ambiguity processor 58 may be configured for providing the ambiguity result so as to indicate at least one of
ambiguity associated with a control unit of the instructing device, e.g., whether the meaning such as left/right indicated in an instruction is unambiguous
ambiguity associated with the instructing device, e.g., a command unit thereof
output related ambiguity associated with the instructing device, e.g., a command unit thereof, providing the command in view of the contextual information and instructions associated hereto
ambiguity associated with a command parser unit of the device
ambiguity associated with the system or process
an indicator whether the command is understood in view of the contextual information [Hint to inventors: 5.2.5 d. of invention disclosure; might be considered unclear in this broad formulation]
a probability whether the command is understood in view of the contextual information [Hint to inventors: 5.2.5 e. of invention disclosure; might be considered unclear in this broad formulation
a context refinement request indicating a request to provide supplementary contextual information about the command chain [about instructing device and/or the instructed device].

The ambiguity processor 58 may be configured for determining the probability as a normalized probability whether the command is understood in view of the contextual information as a normalized probability in which all determined probabilities sum up to a value corresponding to 100%. Alternatively or in addition, the ambiguity processor may determine the probability as an unnormalized probability in which all determined probabilities sum up to a value corresponding to a value differing from 100%.

### Implementing the Device Functions

The combined operation of the system shown in FIG. 12 is now split in half thus allowing the first device and the second device to be discussed separately.

### The Functions of a First Device

FIG. 13 shows the functional blocks of a first device and its interfaces to a second device-note the additional ambiguity input which allows the ambiguity processor to assess the ambiguity provided by both the commander and the command parser (shown in FIG. 14). The ambiguity processor provides an input to the commander which might be used to control the provision of commands to the commander parser. It also provides an input to the system controller which might result in it requesting further contextual information from the first device (instruction context) and/or the second device (system context). This is made possible through the context transfer interface.

### The Functions of a Second Device

FIG. 14 shows the functional blocks of a second device and its interfaces to a first device—note the additional ambiguity input which allows the ambiguity processor to assess the ambiguity provided by both the command parser and the commander (shown in FIG. 13). The ambiguity processor provides an input to the command parser which might be used to control the provision of commands to the commander parser. It also provides an input to the system (process) which might result in it requesting further contextual information from the second device (system context) and/or first device (instruction context). This is made possible through the context transfer interface.

An instructed device described herein, e.g., instructed device 50₁, 50₂, 50₃ and/or 50₄ may be adapted to operate in the command chain 40. However, such a device may be adapted for providing contextual information 22₄ associated with the command chain 40 and/or for providing contextual information associated with a different command chain to which the device does not belong or form a part thereof.

According to an embodiment, an instructed device described herein is adapted for providing the contextual information 22₄ so as to be associated with the second command chain, e.g., upon request or based on a triggering event as is described in connection with the instructing device. In a similar way, the contextual information provided may be generic for a type of the instruction, a type of at least a component of the instructed device, a type of at least a component of the instructing device and a description of the process.

According to an embodiment, the at least one setting 52 provided at the instructed device relate to a control of a subsystem of the device, represented as the system/process 56. The instructed device, e.g., the command parser unit 54 thereof, may be configured for determining a plurality of settings for a same or different subsystems at the instructed device. The plurality of settings may describe a simultaneous or sequential control for the same or different subsystems as a solution to follow the received command, i.e., to arrive at the target behavior. That is, responsive to the command received with the command signal 12, one or more parts of the instructed device may be controlled with one or more particular actions each.

According to any embodiment, e.g., when the received command has a missing information, the instructed device, e.g., the command parser unit 54 may be configured for deriving, from the command contained in the command signal 12 a missing information with respect to a valid setting of the instructed device. The instructed device may derive, from the contextual information, the missing information to obtain at least one valid setting 52.

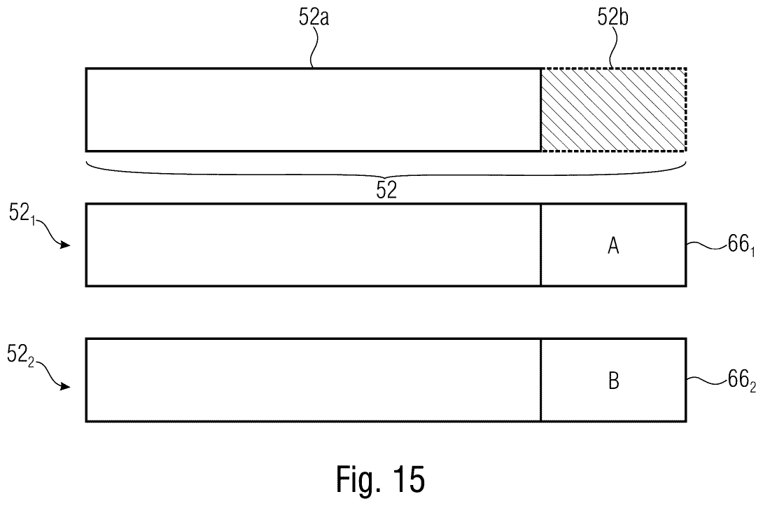

For describing advantageous embodiments, reference is made to FIG. 15. FIG. 15 shows a schematic illustration of a portion 52a of a valid setting that may be derived, for example, from the command contained in the command signal 12. A valid setting 52 misses portion 52b which may be considered as a missing part, a missing information or the like. The instructed device may derive the missing part 52b, e.g., based on the contextual information 22₂. However, such a solution may be unambiguous but may also be ambiguous, i.e., facing ambiguity. This may lead to a possibility of having two or more valid settings 52₁, 52₂ in which the missing part 52b is substituted differently by substituted portions 66₁, 66₂ respectively. The settings 52₁ and 52₂ may thus be considered as interpretations of the command. As described in connection with the ambiguity processor 58, the settings may also be associated with a probability whether the command is understood in view of the contextual information. This may relate to whether the command is understood at all or whether the command is understood correctly.

The instructed device may select one of the settings 52₁ and 52₂ or possibly further settings to be implemented, may send a request to the instructing device or may perform other solutions to reduce or solve ambiguity, e.g., perform a combination of the instruction 52₁ and 52₂, executing each or at least the most likely instruction(s) or the like. That is, by substituting the missing portion 52b it is possible but not necessary that an unambiguous solution is obtained.

For example, assuming a case where the contextual information provides for an ambiguous determination of the setting based on the missing information 52b, i.e., a plurality of possible interpretation or possible solutions, the instructive device, e.g., by use of the command parser unit 54, may be configured for providing a plurality of valid settings 52₁, 52₂, . . . , based on the command. Those plurality may be generated, e.g., one setting for each possible interpretation, a fixed number thereof, e.g., the most probable solution(s), or all settings associated with a probability exceeding a threshold or the like. According to an embodiment, the ambiguity processor 58 may be configured for providing the ambiguity information 64/32 in a case where the contextual information 22₂ provides for an ambiguous determination of the setting based on the missing information 52b.

According to an embodiment, the ambiguity processor 58 may be configured for evaluating an ambiguity of the command with respect to the contextual information 22₂ to obtain the ambiguity information 64/32. The ambiguity processor 58 may be configured for providing the ambiguity information 32 and/or 64 to the instructing device and/or to an entity such as a system/process 56 to cause the entity to provide supplementary contextual information 22₃ and/or 22₄. This may also be obtained by requesting an entity not being part of the command chain to provide for supplementary contextual information.

According to an embodiment, the instructed device may comprise a command parser unit 54 configured for accessing/using the contextual information 22₂ and for generating the setting 52 of the instructed device. The ambiguity processor 58 may be configured for providing the ambiguity result 32/64 so as to indicate ambiguity in at least one of an input of the command parser unit 54, e.g., in the command of the command signal 12, and an output of the command parser unit 54, e.g., the setting 52.

According to an embodiment, the ambiguity in the input of the command parser unit 54 may relate to an ambiguity associated with the command. Alternatively or in addition, the ambiguity in the output of the command parser unit 54 may relate to an ambiguity associated with the setting and/or associated with the instructed device.

Embodiments provide for an instructed device 50₁, 50₂, 50₃ and/or 50₄ that comprises a context interface such as interface 36₂ adapted for a direct or indirect transfer of contextual information to the instructing device and/or an ambiguity interface 34₂ for transmitting ambiguity information to the instructing device, e.g., based on the ambiguity output from the command parser. The interfaces 36₂ and 34₂ may use a common interface together with the interface 14₂ or may be implemented separately. They may use the same or a different radio access technology, RAT, e.g., WiFi®, Bluetooth®, optical interfaces such as IrDA and/or Xn interface.

The ambiguity interface 34₂ may be connected to the command parser unit 54 configured for accessing/using the contextual information 22₂ for generating the setting 52. The ambiguity interface 34₂ may be configured to provide the ambiguity information 64 to the instructing device, e.g., a command unit thereof.

An instructed device in accordance with embodiments may be configured for providing, to the instructing device 10₁, 10₂, 10₃, 10₄ respectively an acknowledgement information indicating an acknowledgement for the command. Such an acknowledgement may indicate whether the command is understood, likely to be understood, likely to be not understood, not understood or erroneous or the like.

According to an embodiment, an instructed device described herein may comprise a control unit configured for implementing and/or executing the setting or a sequence of settings, e.g., at least a part of the system/process 56. Such a control unit may be configured for locking at least one function of the device or a system response of the command chain 40 based on the command. Alternatively or in addition, the same or a different function or a set of functions may be unlocked based on the command. The instructed device in accordance with embodiments described herein may be configured for providing a report to the instructing device reporting the locking and/or unlocking. As was described for the instructing device, the contextual information 22₂ may be accessible for the instructed device at least partly at an internal or external data storage.

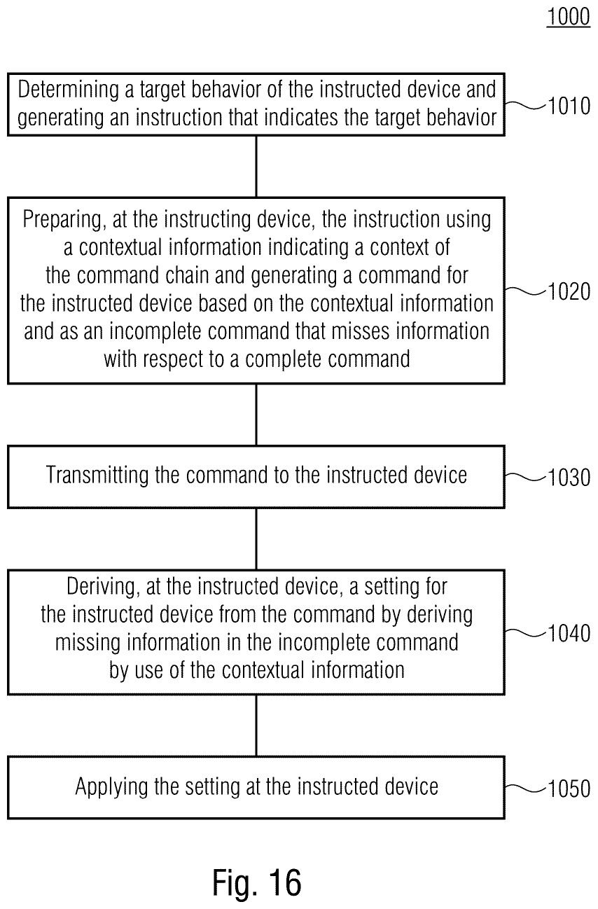

FIG. 16 shows a schematic flow chart of a method 1000 in accordance with an embodiment that may be used for operating a system having a command chain comprising at least one instructing device and an instructed device. A step 1010 comprises determining a target behavior of the instructed device and generating an instruction that indicates the target behavior, e.g., instruction 18. Step 1020 comprises preparing, at the instructing device, the instruction using a contextual information indicating a context of the command chain and generating a command for the instructed device based on the contextual information and as an incomplete command that misses information with respect to a complete command. That is, information that is expected to be known at the instructed device, e.g., by use of the contextual information, is, at least partly, removed from the command.

A step 1030 comprises transmitting the command to the instructed device. A step 1040 comprises deriving, at the instructed device, a setting, e.g., setting 52, for the instructed device from the command by deriving missing information such as information 22b, in the incomplete command by use of the contextual information 22₂. A step 1050 comprises applying the setting at the instructed device.

Method 1000 may be adapted such that the incomplete command relates to a command incorporating a complete set of parameters, wherein the incomplete command misses at least a part of the parameters as missing information.

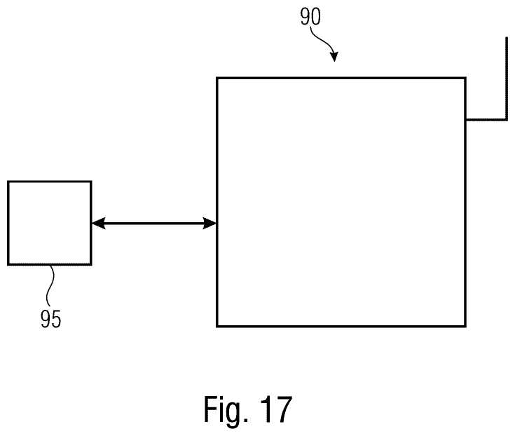

Embodiments described herein relate to receiving and/or generating contextual information. Some embodiments described herein relate to store and/or read such contextual information from a centralized or distributed data storage. Embodiments provide, as an alternative, or in combination with such a memory, a possibility for accessing a digital twin, DT. As shown, for example, in FIG. 17 illustrating a schematic block diagram of a device 90 that may operate as an instructing device and/or as an instructed device in connection with systems described herein, the device 90 may access a digital twin 95 that may be operated or provided on an external device such that for accessing the DT 95 an interface is used. Alternatively or in addition, the DT 95 may be hosted, provided or operated, at least in parts, as a part of a function of the device 90.

The DT may represent a condition of the device or entity of which it is a twin. That is, DT 95 may be a twin of a instructing device described herein and/or a instructed device described herein. From view of the device 90 operating as an instructing device the device 90 may be adapted for accessing DT 95 representing the instructed device, e.g., the device 50₁, 50₂, 50₃ and/or 50₄ and for deriving, based on the DT 95, at least a part of the contextual information 22₁ and/or 22₃. Alternatively or in addition, the instruction 18 relating to the target behavior of the instructed device may be derived, e.g., by using the DT 95 thereof. Accordingly, as an alternative or in addition, the command 24 may be derived from the DT. Alternatively or in addition with this description, the DT 95 may be a twin of the instructing device 10₁, 10₂, 10₃ and/or 10₄. Based on the DT, at least a part of at least one of the contextual information, the instruction and the command may be derived. This may relate to operating DT 95 so as to represent one of the instructing device and the instructed device or a combination thereof. Possibly, the DT 95 may also incorporate other elements of the network. By accessing the DT 95, the condition and/or a reason for the present condition of the respective device may be evaluated which may provide for contextual information.

The respective DT of the instructing device and/or the instructed device may serve as a provider and/or collector of contextual information, the contextual information relating to at least one of
a settings of the instructed device
a state of the instructing device or of the instructed device
a capability of the instructing device or of the instructed device
an availability of the instructing device or of the instructed device
a behaviour of the instructing device or of the instructed device
a constraint/performance limitation of a control loop/a controlled system
a condition of the instructing device or of the instructed device
a permission of the instructing device or of the instructed device
an accuracy of the instructing device or of the instructed device
a reliability of the instructing device or of the instructed device

From view of the instructed device, the device 90 may be adapted for accessing the DT 95 so as to be a twin of the instructing device 10₁, 10₂, 10₃ and/or 10₄ and for deriving, based on the DT 95, at least a part of at least one of the contextual information 22₂ and/or 22₄, the setting 52 and/or the operation of the instructed device. Alternatively or in addition, the device 90 as the instructed device may be adapted for accessing the DT 95 so as to be a twin of the instructed device 50₁, 50₂, 50₃ and/or 50₄ and for deriving, based on the DT 95, at least a part of at least one of the contextual information 22₂ and/or 22₄, the setting 52 and/or the operation.

In both variations, whether the DT 95 is twin of the instructing device and/or the instructed device, the DT 95 may be a provider and/or collector of contextual information, the contextual information relating to at least one of
a settings of the instructed device
a state of the instructing device or of the instructed device
a capability of the instructing device or of the instructed device
an availability of the instructing device or of the instructed device
a behaviour of the instructing device or of the instructed device
a constraint/performance limitation of a control loop/a controlled system
a condition of the instructing device or of the instructed device
a permission of the instructing device or of the instructed device
an accuracy of the instructing device or of the instructed device
a reliability of the instructing device or of the instructed device

### Interface Examples that Make Use of the Data and Control Planes

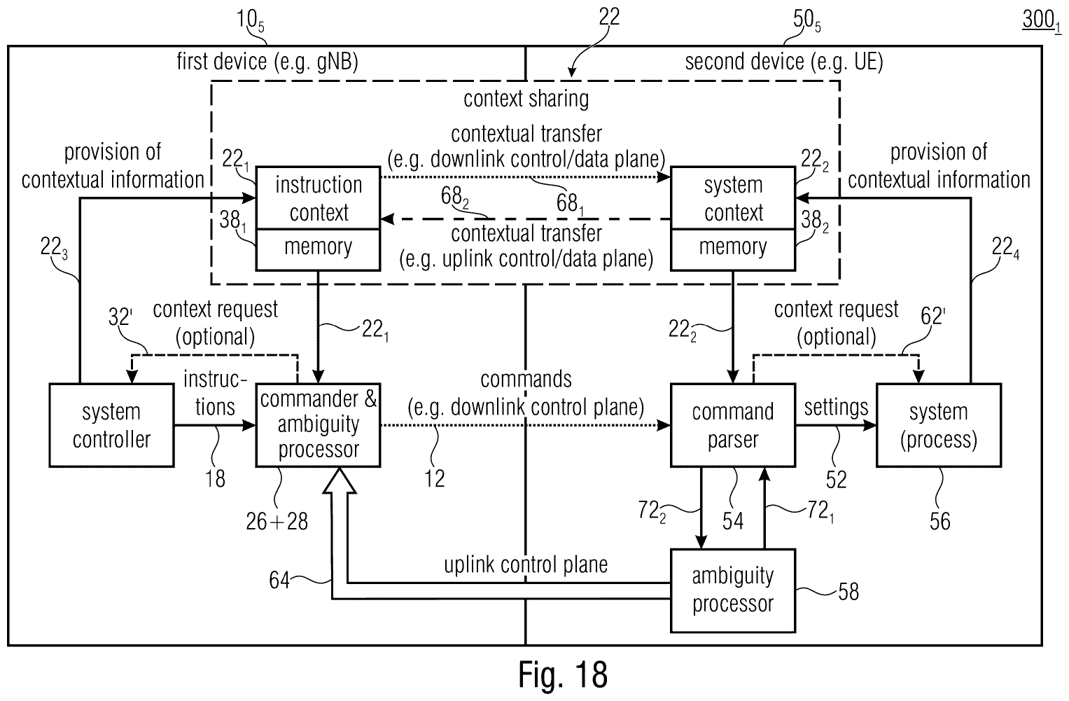

FIG. 18 shows the connection of a first network entity 10₅ and second network entity 50₅ or device of a system 300₁ in which the former processes instructions 18 in order to provide the appropriate commands to the latter. The flow of information within each device and between devices is shown according to an embodiment. In this figure, an ambiguity processor 58, provided within the functionality of the second device 50₅, transfers information to both the command parser 54 and the commander & ambiguity processor 26+28 of the first device 10₅. Contextual information 22 is shared between the two devices using the downlink control or data planes 68₁ in one direction (from first to second device) and the uplink control or data planes 68₂ in the other direction (from second device to first device). Commands are transferred from the first device to the second device via the downlink control plane.

The contextual information 22₁ and/or 22₂ may be stored, for example, in a respective memory 38₁, 38₂ respectively, each formable by a centralized or distributed memory. Whilst not excluding a shared memory, this allows to have instruction related context 22₁ in memory 38₁ and system-related context 22₂ in memory 38₂.

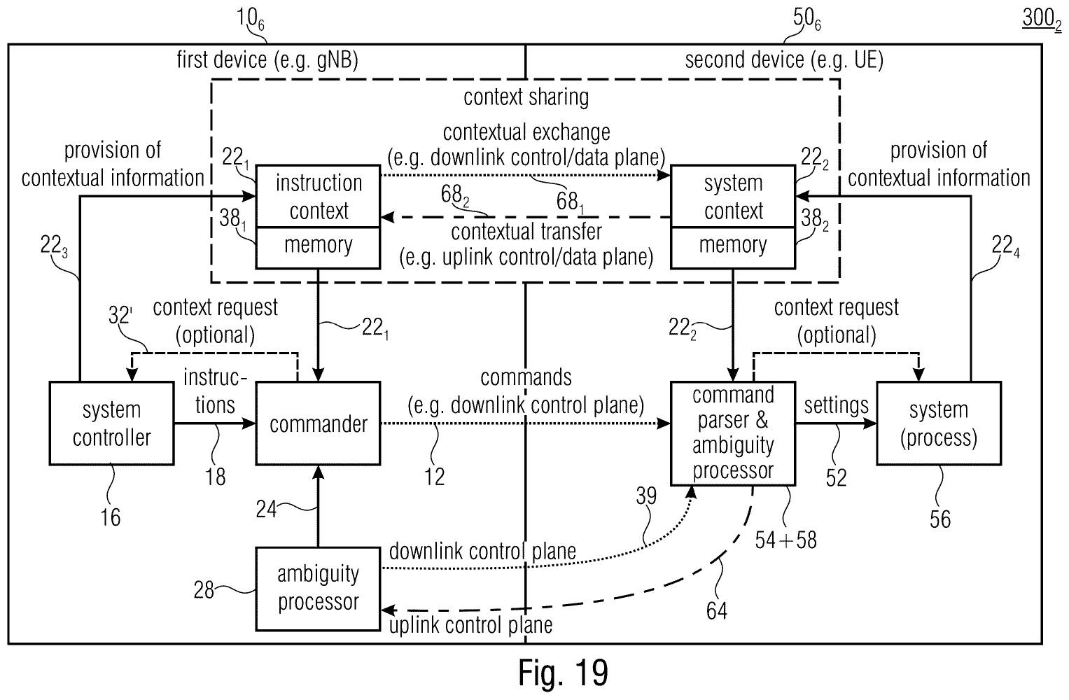

FIG. 19 shows the connection of a first network entity 10₆ and second network entity or device 10₆ of a system 300₂ in which the former processes instructions in order to provide the appropriate commands to the latter. The flow of information within each device and between devices is shown. In this figure, an ambiguity processor 28, provided within the functionality of the first device, transfers information to both the commander and the command parser & ambiguity processor of the second device. The ambiguity processor 28 may further provide for ambiguity information 39 to the ambiguity processor 58 or a combined entity of the instructed device 50₆.

Contextual information is shared between the two devices using the downlink control or data planes in one direction (from first to second device) and the uplink control or data planes in the other direction (from second device to first device). Commands are transferred from the first device to the second device via the downlink control plane as shown in FIG. 18 and FIG. 19 a set of functions may be implemented in a common element, e.g., the combination of command unit 26 and ambiguity processor 28 in FIG. 18 and/or the combination of command parser unit 54 and ambiguity processor 58 in FIG. 19.

### Standardizing the Interface

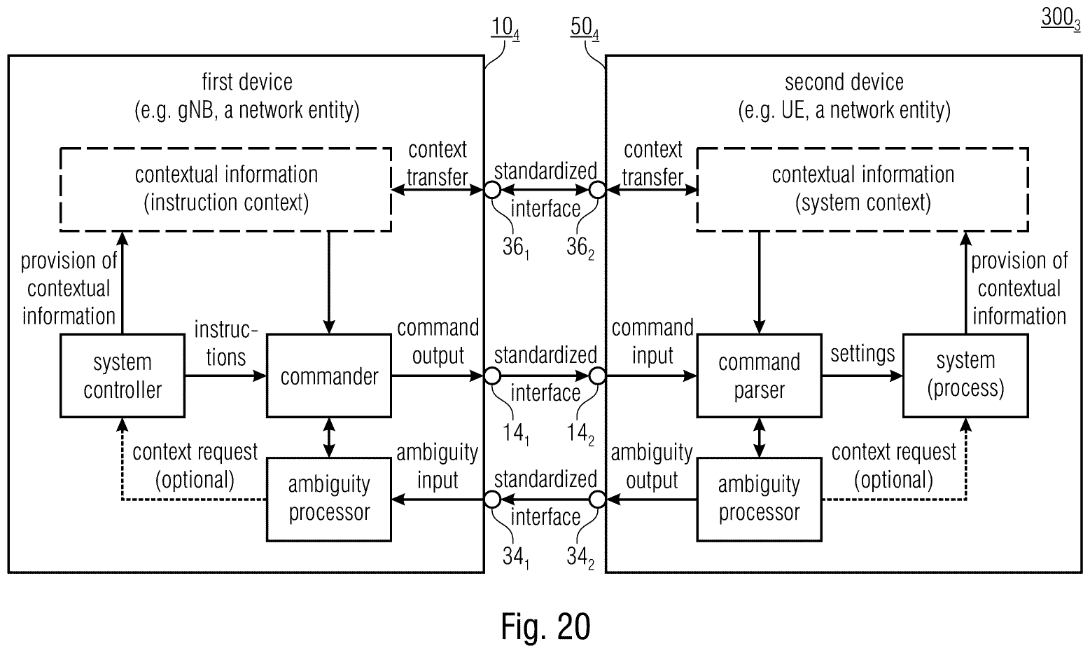

The manner by which the functional blocks are arranged, interconnected and implemented is likely to be decided by the manufacturer of the device and is therefore considered to be “implementation specific” or “proprietary”. However, in order for a first and a second device to be used in contextual command system, a standardized interface is necessary as shown in FIG. 20 showing the devices 10₄ and 50₄ of FIG. 13 and FIG. 14 showing the interconnection the devices using standardized interfaces. The standardized interface is needed to ensure that the two devices understand the commands, messages, formats, protocols, timings and scheduling of the information exchanged and transferred between them. On the other hand, since the interface can be implemented using any wired or wireless means, it might not be necessary to standardize this aspect.

Before additional embodiments of the present invention are illustrated by use of further figures, reference is made again to one of the findings on which the present invention is based. The present invention has recognized that a use of contextual information allows for a high interoperability and/or for a low communication overhead. Whilst considering, at an instructing device a context of the instructing device, the instructed device and/or a system environment the instructing device can rely on formulating its instruction in a more generalized way. For example, instructions in accordance with present embodiments may indicate to reduce interference, provide for a multipath component, implement a generic action such as provide for additional beams or the like, save power, e.g., in a context so as to provide for a maximum battery lifetime or the like. From such instructions, the instructing device may derive associated commands that rely on contextual information. On the other hand, at the instructed device, contextual information may allow to interpret the commands to arrive at the target behavior possibly without being provided with sufficient information by way of the commands as a remaining information is derived from the contextual information.

For example, in view of reducing interference, the contextual information may allow to provide for details, where the interference is to be reduced or in which frequency range, e.g., knowing at which frequency range the victim (instructing device or device connected hereto) suffers interference.

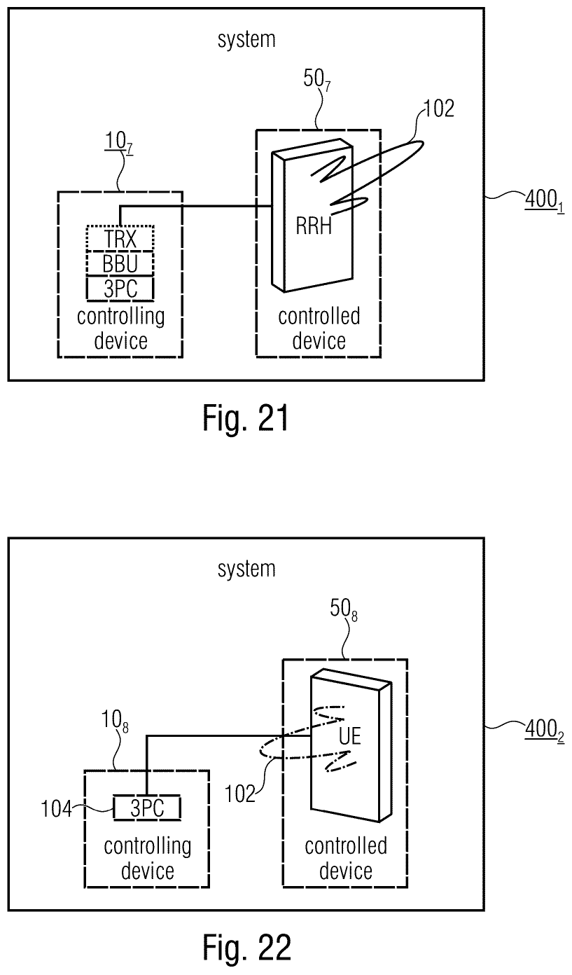

FIG. 21 shows an example of a system 400₁ according to an embodiment having a controlling device 10₇ (which itself comprises a 3PC) and a controlled device. The system is a gNB, the controlling device 10₇ is basestation equipment comprising a transmitter, TRX, connected to a base-band-unit, BBU, and a functional 3PC and the controlled device 507 is an active antenna system such as an electronically steered antenna or a remote radio head, RRH to form a beam pattern. A number of formable beam patterns may be any number of at least 1 in every embodiment described herein.

FIG. 22 shows an example of a system 400₂ according to an embodiment showing a controlling device 10₈ (a 3PC 104) and a controlled device 50₈. The system is a deployed UE to form a beam pattern 102, the controlling device 10₈ is a functional third party controller (3PC) and the controlled device is an active antenna system such as an electronically steered antenna.

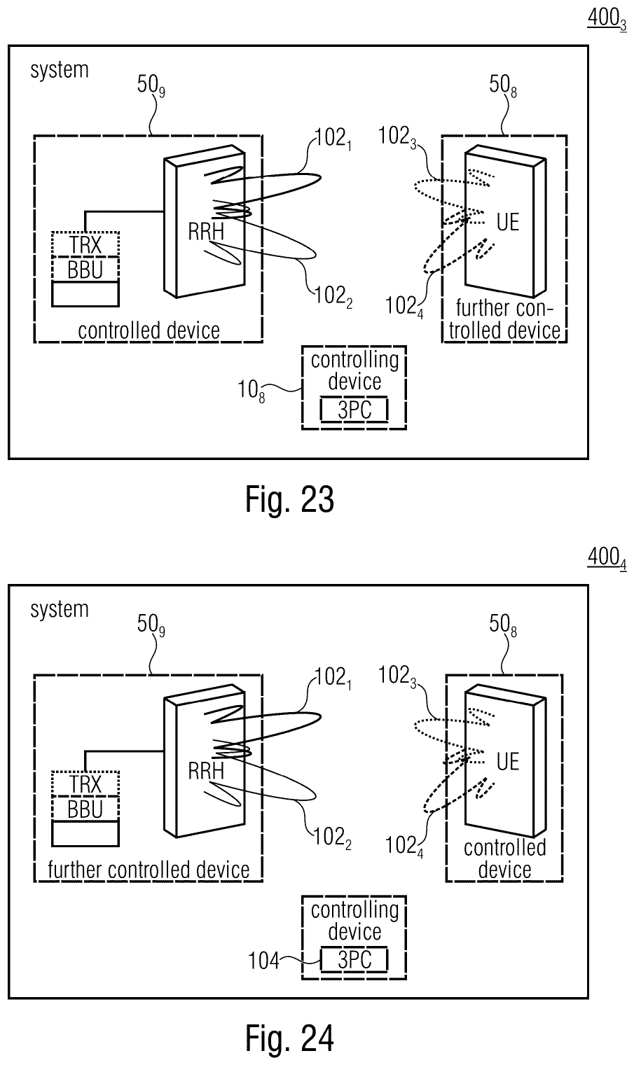

FIG. 23 shows an example of a system 400₃ according to an embodiment comprising a controlling device 10₈ (a functional 3PC 104), a controlled device 50₉ to form beam patterns 102₁ and 102₂ (a gNB) and a further controlled device 50₈ (a UE) to form beam patterns 102₃ and 102₄. A number of formable beam patterns may be any number of at least 1.

FIG. 24 An example of a system 400₄ according to an embodiment comprising a controlling device 10₈ (a functional 3PC 104), a controlled device 50₈ (a UE) and a further controlled device (a gNB) 50₉.

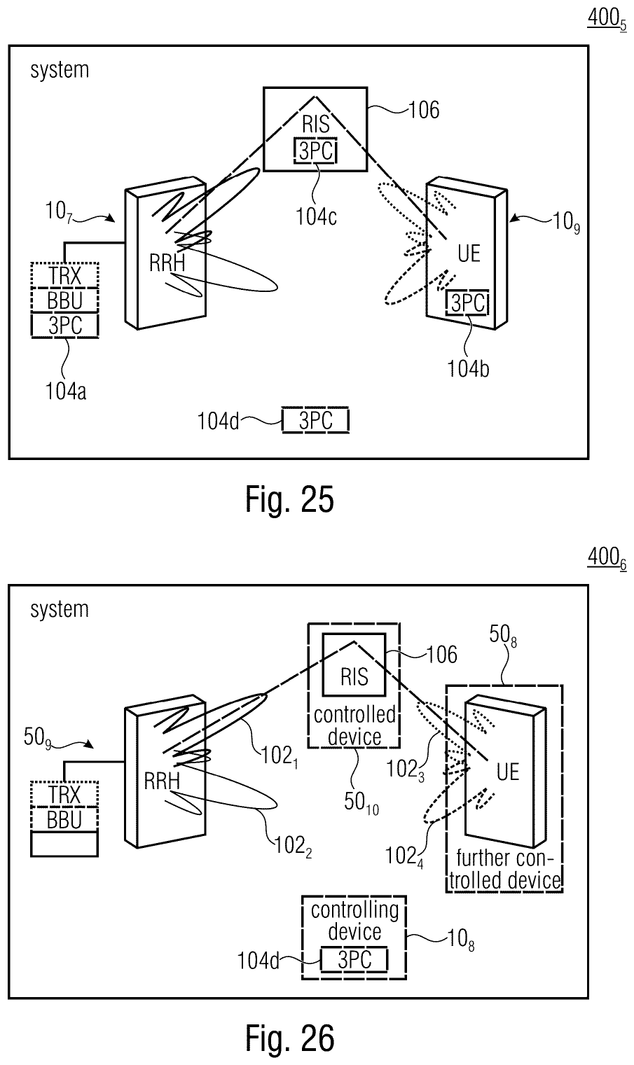

FIG. 25 shows an example of a system 400₅ according to an embodiment showing a variety of possible 3PC implementations 104a-104d, i.e., arrangements of a 3PC 104: within the gNB 10₇; within the UE 10₉; or within the network system, e.g., as part of a reflective intelligent surface, RIS, 106. The 3PC can be implemented a dedicated hardware 104d control or as an entity whose function is defined in software.

FIG. 26 shows an example of a system 400₆ according to an embodiment comprising a controlling device 10₈ (a functional 3PC 104d), a controlled device (comprising a RIS 106) and a further controlled device 50₈ (a UE).

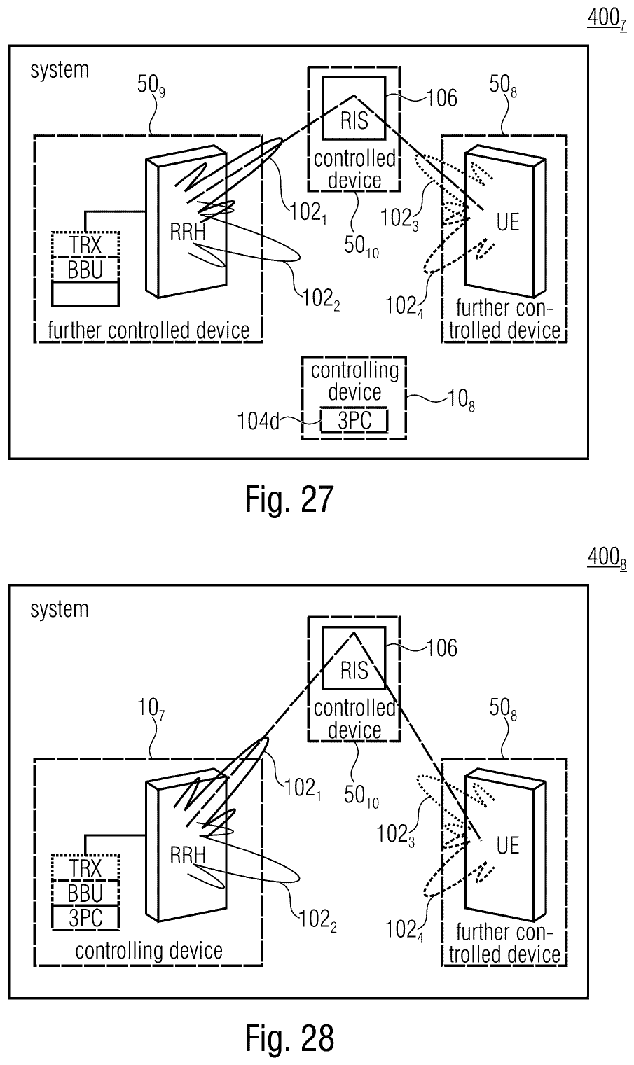

FIG. 27 shows an example of a system 4007 according to an embodiment comprising a controlling device 10₈ (a functional 3PC 104d), a controlled device 50₁₀ (comprising a RIS 106) and two further controlled devices (a gNB 50₉ and a UE 50₈).

FIG. 28 shows an example of a system 4008 according to an embodiment comprising a controlling device 10₇ (a functional 3PC within a gNB), a controlled device 50₁₀ (comprising a RIS 106) and a further controlled device 50₈ (a UE).

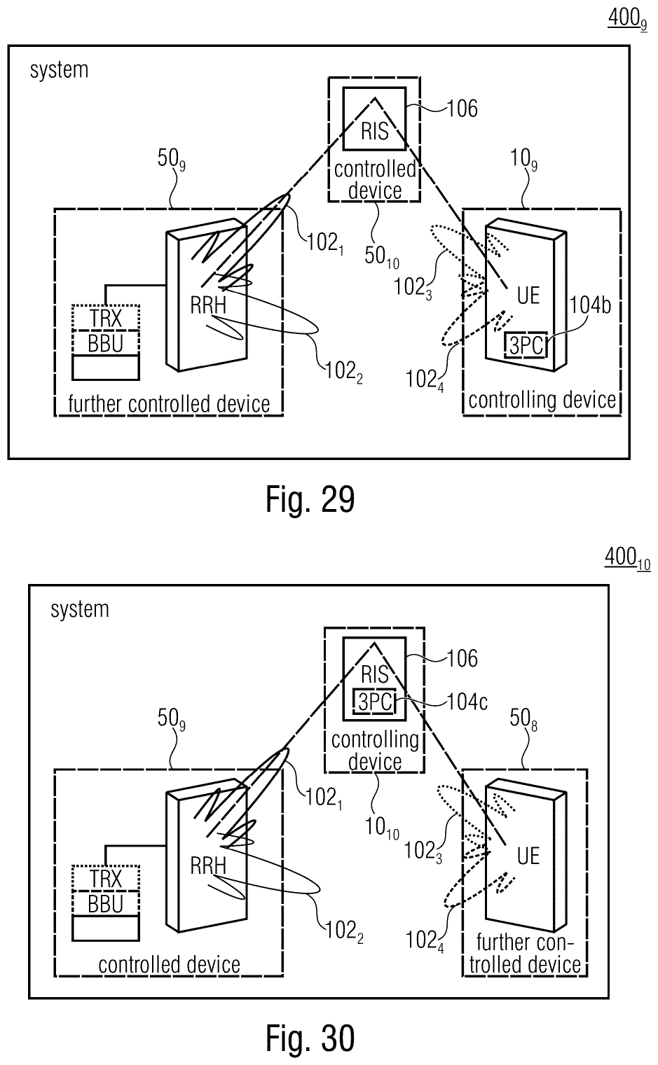

FIG. 29 shows an example of a system 400g according to an embodiment comprising a controlling device 10₉ (a functional 3PC within a UE), a controlled device 50₁₀ (comprising a RIS 106) and a further controlled device 50₈ (a gNB).

FIG. 30 shows an example of a system 40010 according to an embodiment comprising a controlling device 10₁₀ (a functional 3PC within a RIS 106), a controlled device 50₉ (a gNB) and a further controlled device 50₈ (a UE).

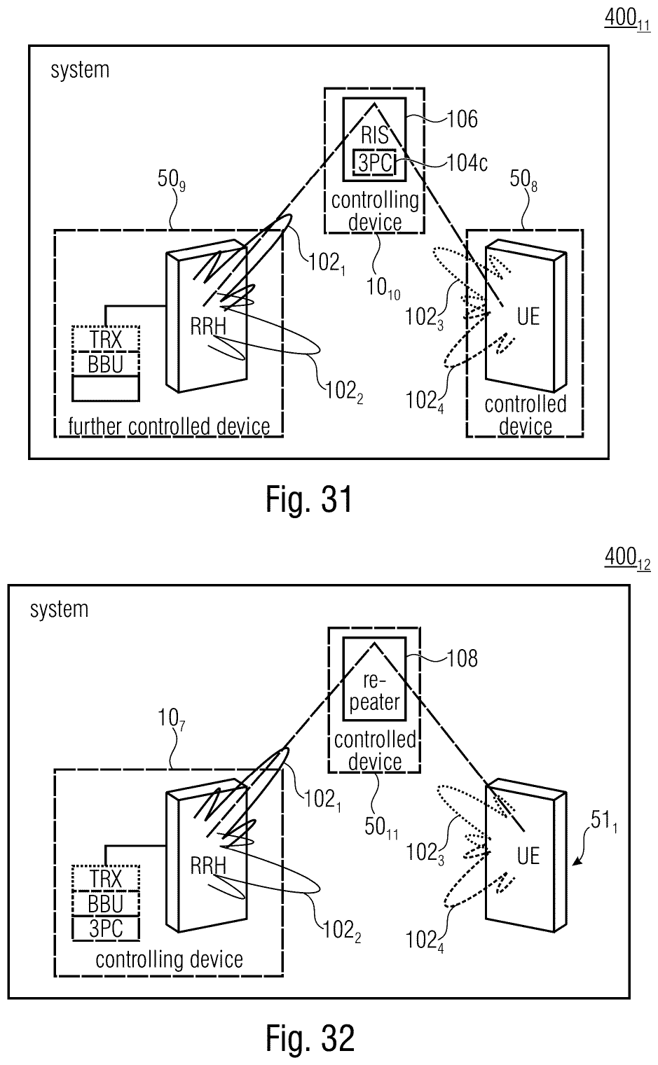

FIG. 31 shows an example of a system 40011 according to an embodiment comprising a controlling device 10₁₀ (a functional 3PC within a RIS 106), a controlled device 50₈ (a UE) and a further controlled device 50₉ (a gNB).

FIG. 32 shows an example of a system 40012 according to an embodiment comprising a controlling device 10₇ (a functional 3PC within a gNB) and a controlled device 50₁₁ (comprising a repeater 108) A device 51₁ uncontrolled by 3PC 10₇ may be, for example, a UE and may form a basis (at least by its behaviour, e.g., its beam patterns 102₃ and/102₄) for the control of the controlling device 10₇ so as to adapted the behaviour of remaining entities.

Having a controlling device 10₇ together with a controllable repeater and/or RIS as controlled device 50₁₁ may allow to coordinate behaviour with regard to other devices, possibly uncontrolled in view of the aimed overall behaviour, for example, a direction of beams being emitted by device 51₁. The instructing device 10₇ may facilitate its communication with device 51₁ by use of the controlled device 50₁₁.

According to an embodiment, the contextual information 22 may relate to an instructing device such as device 10₇, an instructed device 50₁₁ and/or or a different entity.

According to an embodiment, an instructing device described herein such as device 10₇ is adapted so as to generate the command signal comprising an indication for an instructed device described herein, being a beamforming device such as a repeater or a reconfigurable intelligent surface, RIS, to point a beam of the instructed device towards a specific direction or location or to exclude the specific direction or location from a beam pattern generated by the instructed device.

According to an embodiment, the specific direction or location is associated with a position of another device, e.g., device 51₁ such as a communication partner of the instructing device. This may allow to instruct instructed device 50₁₁ to point any or a specific beam or combination of transmission and/or reception beams towards device 51₁, e.g., to facilitate communication with device 10₇ or to exclude said position/direction from illumination, e.g., for interference mitigation.

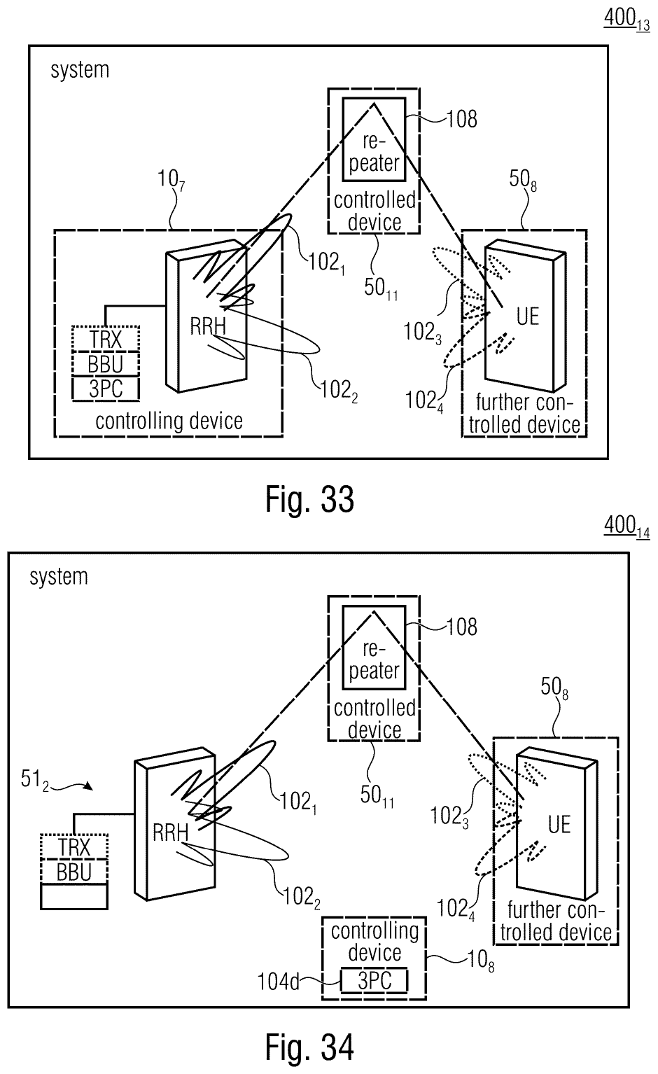

FIG. 33 shows an example of a system 400₁₃ according to an embodiment comprising a controlling device 10₇ (a functional 3PC within a gNB), a controlled device 50₁₁ (comprising a repeater 10₈) and a further controlled device 50₈ (a UE).

FIG. 34 shows an example of a system 400₁₄ according to an embodiment comprising a controlling device 10₈ (a functional 3PC), a controlled device 50₁₁ (comprising a repeater 10₈) and a further controlled device 50₈ (a UE). A device 512 uncontrolled by instructing device 10₈ may be, for example, a gNB and may for a basis for the control of the controlling device 10₈ so as to adapted the behaviour of remaining entities.

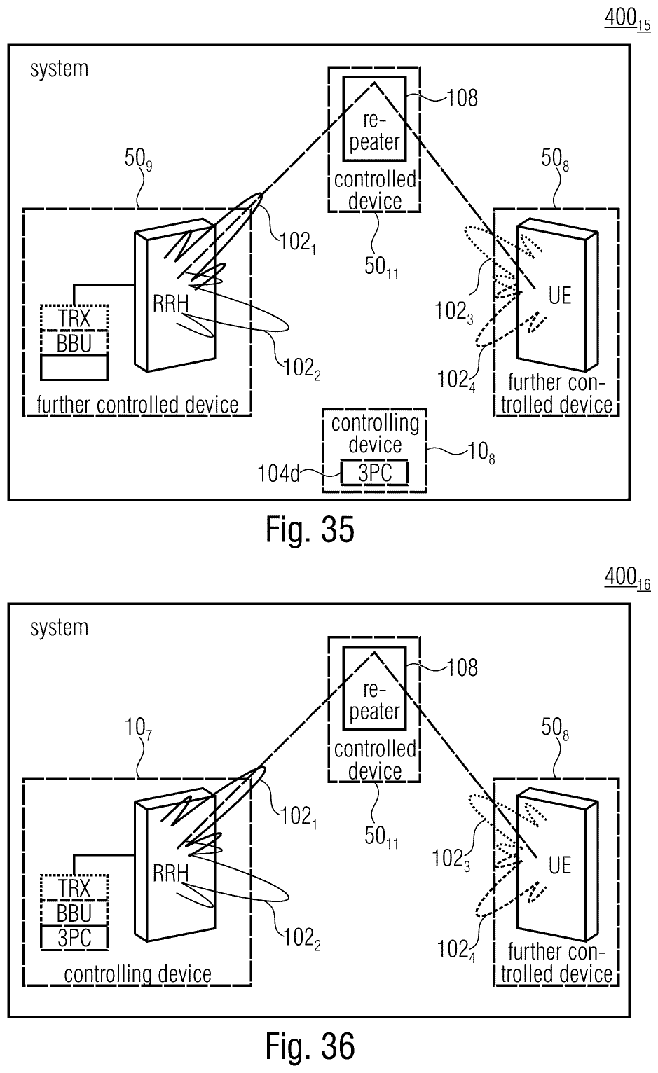

FIG. 35 shows an example of a system 400₁₅ according to an embodiment comprising a controlling device 10₈ (a functional 3PC), a controlled device (comprising a repeater 10₈) and two further controlled devices 50₈ and 50₉ (a gNB and a UE).

FIG. 36 shows an example of a system 400₁₆ according to an embodiment comprising a controlling device 10₇ (a functional 3PC within a gNB), a controlled device 50₁₁ (comprising a repeater 10₈) and a further controlled device 50₈ (a UE).

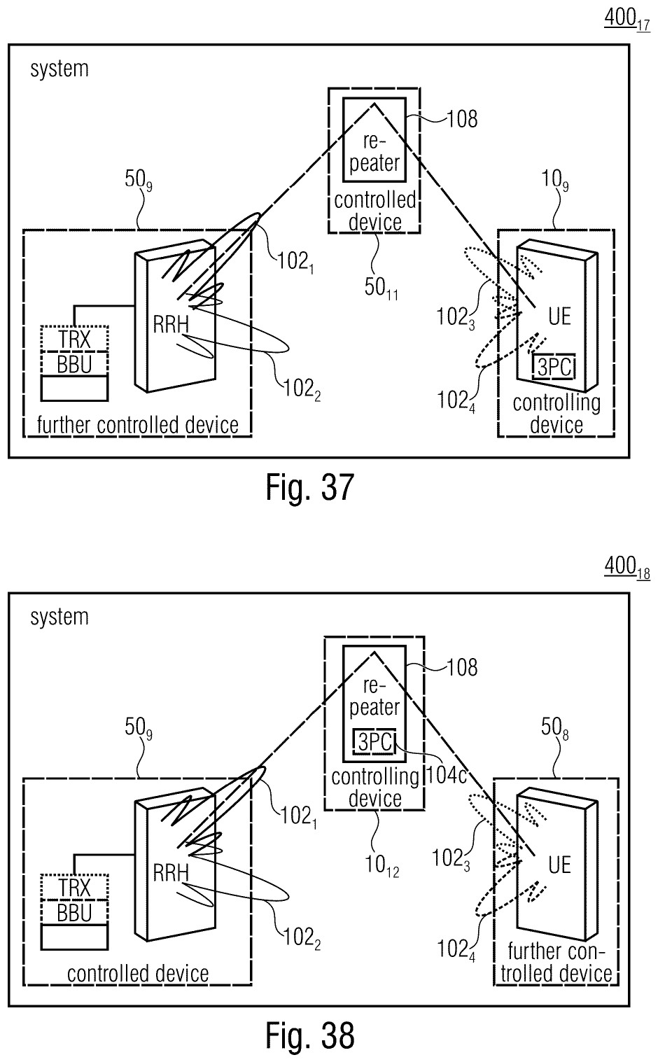

FIG. 37 shows an example of a system 400₁₇ according to an embodiment comprising a controlling device 10₉ (a functional 3PC within a UE), a controlled device 50₁₁ (comprising a repeater 10₈) and a further controlled device 50₉ (a gNB).

FIG. 38 shows an example of a system 40018 according to an embodiment comprising a controlling device 10₁₂ (a functional 3PC within a repeater 10₈), a controlled device 50₉ (a gNB) and a further controlled device 50₈ (a UE).

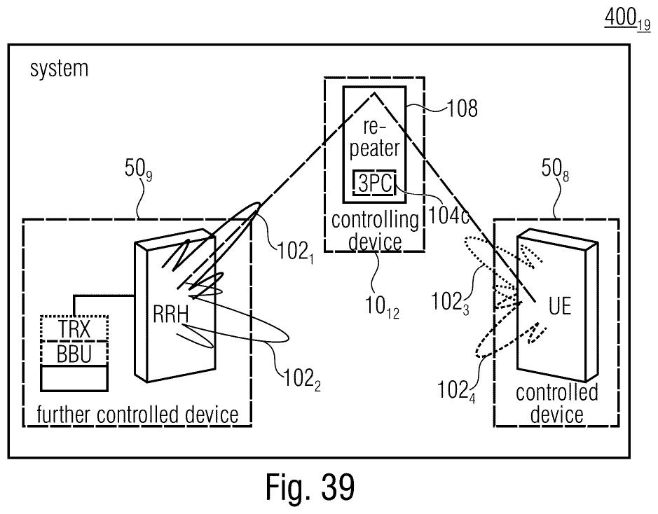

FIG. 39 shows an example of a system 40019 according to an embodiment comprising a controlling device 10₁₂ (a functional 3PC within a repeater 10₈), a controlled device 50₈ (a UE) and a further controlled device 50₉ (a gNB).

It is to be noted that a number of controlled devices is arbitrary and, advantageously, at least one. As shown, the number of controlled devices may also be a higher number, e.g., 2, 3, 4, 5 or even larger. This allows to orchestrate a behaviour of devices, e.g., by a 3PC 104. For example, a selection, orientation, power control or the like of beam patterns 102₁ to 102₄ may be adapted so as to provide for an efficient communication, possibly by using RIS 106 and/or repeaters 108 incorporated by third parties or the like.

In the following, additional embodiments and aspects of the invention will be described which can be used individually or in combination with any of the features and functionalities and details described herein.

According to a first aspect, a device configured for transmitting a command signal as an instructing device 50 and to an instructed device 50 forming a command chain 40 with the instructing device 50 comprises: an interface 14 configured for transmitting the command signal 12; a control unit 16 configured for providing an instruction signal comprising an instruction 18 associated to a target behaviour of the instructed device 50; wherein the device is configured for accessing/using contextual information 22 indicating a context of the command chain 40 and for generating a command 24 from the instruction based on the contextual information 22; wherein the command 24 is associated with an operation of the instructed device 50; or providing contextual information 22 indicating a context of the command chain 40 for interpretation of a command belonging to the command chain 40, wherein the device is configured for transmitting the command signal 12 comprising the command 24 using the interface.

According to a second aspect when referring back to aspect 1, the device comprises a command unit 26 configured for accessing/using the contextual information 22 and for generating the command.

According to a third aspect when referring back to aspect 1 or 2, the command chain 40 is a first command chain; wherein the device is adapted for providing contextual information 22 associated with the first command chain; and/or for providing contextual information 22 associated with a second command chain, the device not being part of the second command chain.

According to a fourth aspect when referring back to aspect 3, the device is adapted for providing contextual information 22 associated with the second command chain, upon request or based on a triggering event.

According to a fifth aspect when referring back to aspect 3 or 4, the contextual information 22 contains a generic information that is generic for a type of the instruction; a type of at least a component of the device; a type of at least a component of the instructed device; a description of the process.

According to a sixth aspect when referring back to one of the previous aspects, the device is adapted for accessing a first digital twin, DT 95, of the instructed device 50 and for deriving, based on the DT 95, at least a part of at least one of the contextual information 22, the instruction 18 and the command 24; and/or accessing a second digital twin, DT 95, of the device and for deriving, based on the DT 95, at least a part of at least one of the contextual information 22, the instruction 18 and the command 24.

According to a seventh aspect when referring back to aspect 6, the first DT 95 and/or the second DT is a provider and/or collector of contextual information 22, the contextual information 22 relating to at least one of: a settings of the instructed device, a state of the instructing device or of the instructed device, a capability of the instructing device or of the instructed device, an availability of the instructing device or of the instructed device, a behaviour of the instructing device or of the instructed device, a constraint/performance limitation of a control loop/a controlled system, a condition of the instructing device or of the instructed device, a permission of the instructing device or of the instructed device, an accuracy of the instructing device or of the instructed device, a reliability of the instructing device or of the instructed device.

According to an eight aspect when referring back to one of the previous aspects, the device, e.g., a command unit thereof, is configured for deriving, from the contextual information 22, expectedly known information that is expected to be known at the instructed device 50 and to remove or substitute the expectedly known information from the command 24.

According to a ninth aspect when referring back to one of the previous aspects, the device comprises an ambiguity processor 28 configured for evaluating an ambiguity of the instruction 18 with respect to the contextual information 22 and/or to receive ambiguity information 64 provided by the instructed device 50 to obtain an ambiguity result 32; wherein the ambiguity processor 28 is configured for providing the ambiguity result 32 to the control unit; wherein the control unit 16 is configured for reducing the ambiguity based on the ambiguity result 32.

According to a tenth aspect when referring back to aspect 9, the control unit 16 is configured for providing a new instruction signal comprising a new instruction 18 associated to the target behaviour, the new instruction 18 containing supplementary information and/or a supplementary instruction 18 when compared to the instruction 18 to reduce the ambiguity; and/or wherein the control unit 16 is configured for providing supplementary contextual information 22₃ about the device for decreasing the ambiguity at the instructed device 50; and/or wherein the control unit 16 is configured for controlling the device to send a request to the instructed device 50 for providing a supplementary contextual information 22₄ about the instructed device 50.

According to an eleventh aspect when referring back to aspect 10, the control unit 16 is configured for providing the new instruction signal so as to comprise a change in a parameter of the instruction 18 and/or at least one additional parameter when compared to the instruction 18.

According to a twelfth aspect when referring back to aspect 10 or 11, the device, e.g., a command unit 26 thereof is configured for generating a new command signal 12 containing a new command 24 based on the new instruction signal and based on the contextual information 22; wherein, when compared to the command signal, the new command signal comprises at least one of: information with increased granularity; an additional data field containing an additional parameter; and an additional side constraint for the target behaviour.

According to a thirteenth aspect when referring back to one of aspects 10 to 12, the device, e.g., a command unit 26 thereof is configured for using additional contextual information 22₃, 22₄ provided by the device or a different device for providing the new command signal; wherein, based on the additional contextual information 22 the control unit 16 is configured for reducing an amount of information contained in the new command signal when compared to the instruction signal.

According to a fourteenth aspect when referring back to one of aspects 10 to 13, the device comprises a command unit 26 configured for accessing the contextual information 22 and for generating the command 24; wherein the ambiguity processor 28 is configured for providing the ambiguity result 32 so as to indicate ambiguity in at least one of an input of the command unit and an output of the command unit.

According to a fifteenth aspect when referring back to aspect 14, the ambiguity in the input of the command unit 26 relates to an ambiguity associated with the control unit 16; and/or associated with the instruction 18; or wherein the ambiguity in the output of the command unit 16 relates to an ambiguity associated with the instruction 18; and/or associated with the command 24.

According to a sixteenth aspect when referring back to one of aspects 9 to 15, the ambiguity processor 28 is configured for providing the ambiguity result 32 so as to indicate at least one of: ambiguity associated with the control unit, e.g., whether the meaning such as left/right is unambiguous, ambiguity associated with a command unit, output related ambiguity associated with the command unit in view of the contextual information and the instruction, ambiguity associated with a command parser unit of the instructed device, ambiguity associated with a system or process of the instructed device, an indicator whether the instruction is understood in view of the contextual information, a probability whether the instruction is understood in view of the contextual information, an indicator whether the command is→understood/clear in view of the CI, a context refinement request indicating a request to provide supplementary contextual information about the command chain.

According to a seventeenth aspect when referring back to one of the previous aspects, the control unit 16 is configured for an evaluation whether a behaviour of the instructed device 50 corresponds to the target behaviour.

According to an eighteenth aspect when referring back to aspect 17, the control unit is configured for using, for the evaluation at least one of: a measurement report reporting about a measurement associated with the behaviour; an updated contextual information being updated based on the behaviour; a feedback received from the instructed device.

According to a nineteenth aspect when referring back to aspect 17 or 18, the control unit is configured, within the evaluation, for comparing the behaviour of the instructed device 50 with the target behaviour and for determining a deviation between the behaviour of the instructed device 50 and the target behaviour; and for providing an updated instruction with regard to the target behaviour or an updated target behaviour based on the deviation.

According to a twentieth aspect when referring back to aspect 19, the control unit 16 is configured for correlating the deviation with the contextual information 22 available to the device 10 or the instructed device 50 and for updating the contextual information 22 and/or considering, in the updated instruction, the deviation.

According to a twenty-first aspect when referring back to one of the previous aspects, the control unit 16 and a command unit 26 of the device, the command unit configured for accessing the contextual information 22 and for generating the command 24; are functionally arranged totally within the instructing device 10 or at most partly as a network entity of a network comprising the instructing device 10.

According to a twenty-second aspect when referring back to one of the previous aspects, the device comprises: a context interface 36 for context transfer to directly or indirectly transfer contextual information 22 to the instructed device; and/or an ambiguity interface 34 for receiving ambiguity information 64 from the instructed device 50.

According to a twenty-third aspect when referring back to one of the previous aspects, the command signal 12 is a first command signal, wherein the device is configured for using additional contextual information 22₃, 22₄ provided by the device or a different device for providing a second command signal for a same instruction signal; wherein, based on the additional contextual information 22₃, 22₄ the device is configured for reducing an amount of information contained in the second command signal when compared to the first command signal 12.

According to a twenty-fourth aspect when referring back to one of the previous aspects, the contextual information 22 is accessible for the device at least partly at an internal or external data storage 38.

A twenty-fifth aspect relates to a device configured for operating based on a received command as an instructed device of a command chain 40, the device comprising: an interface 14 configured for receiving a command signal 12 comprising the command; wherein the device is configured for accessing/using contextual information 22 indicating a context of the command chain 40 and for generating a setting 52 of the device from the command based on the contextual information 22; wherein the setting 52 is associated with an operation of the device; wherein the device is configured for implementing and/or executing the setting 52.

According to a twenty-sixth aspect when referring back to aspect 25, the device comprises a command parser unit 54 configured for accessing/using the contextual information 22 and for generating the setting 52 of the device.

According to a twenty-seventh aspect when referring back to aspect 25 or 26, the command chain 40 is a first command chain; wherein the device is adapted for providing contextual information 22₄ associated with the first command chain; and/or for providing contextual information associated with a second command chain, the device not being part of the second command chain.

According to a twenty-eighth aspect when referring back to aspect 27, the device is adapted for providing contextual information associated with the second command chain, upon request or based on a triggering event.

According to a twenty-ninth aspect when referring back to aspect 27 or 28, the contextual information contains a generic information that is generic for a type of the instruction; a type of at least a component of the device; a type of at least a component of the instructing device; a description of the process.

According to a thirtieth aspect when referring back to one of aspects 25 to 29, the device is adapted for accessing a first digital twin, DT 95, of the instructing device and for deriving, based on the first DT 95, at least a part of at least one of the contextual information 22, the setting 52 and the operation; and/or wherein the device is adapted for accessing a second digital twin, DT 95, of the device and for deriving, based on the second DT 95, at least a part of at least one of the contextual information 22, the setting and the operation.

According to a thirty-first aspect when referring back to aspect 30, the first DT and/or the second DT is a provider and/or collector of contextual information, the contextual information relating to at least one of: a settings of the instructed device; a state of the instructing device or of the instructed device; a capability of the instructing device or of the instructed device; an availability of the instructing device or of the instructed device; a behaviour of the instructing device or of the instructed device; a constraint/performance limitation of a control loop/a controlled system; a condition of the instructing device or of the instructed device; a permission of the instructing device or of the instructed device; an accuracy of the instructing device or of the instructed device; a reliability of the instructing device or of the instructed device

According to a thirty-second aspect when referring back to one of aspects 25 to 31, the settings relate to a control of a subsystem of the device; wherein the device, e.g., a command parser unit 54 thereof, is configured for determining a plurality of settings for a same or different subsystems; the plurality of settings describing a simultaneous or sequential control for the same or different subsystems as a solution to follow the received command.

According to a thirty-third aspect when referring back to one of aspects 25 to 32, the device, e.g., a command parser unit 54 thereof is configured for deriving, from the command a missing information with respect to a valid setting of the device; and to derive, from the contextual information 22, the missing information to obtain at least one valid setting.

According to a thirty-fourth aspect when referring back to aspect 33, the device, e.g., a command parser unit thereof, is configured for providing a plurality of valid settings based on the command in a case where the contextual information 52 provides for an ambiguous determination of the setting based on the missing information.

According to a thirty-fifth aspect when referring back to aspect 33 or 34, the device comprises an ambiguity processor 58 configured for providing an ambiguity information 32, 64 in a case where the contextual information 22 provides for an ambiguous determination of the setting based on the missing information.

According to a thirty-sixth aspect when referring back to one of aspects 25 to 35, the device comprises an ambiguity processor 58 configured for evaluating an ambiguity of the command with respect to the contextual information 22 to obtain ambiguity information 64; wherein the ambiguity processor 28 is configured for providing the ambiguity information 64 to an instructing device from which the command signal and/or to an entity of the device to cause the entity to provide supplementary contextual information.

According to a thirty-seventh aspect when referring back to aspect 35 or 36, the device comprises a command parser unit 54 configured for accessing/using the contextual information 22 and for generating the setting 52 of the device; wherein the ambiguity processor 58 is configured for providing the ambiguity result so as to indicate ambiguity in at least one of an input of the command parser unit 54 and an output of the command parser unit 54.

According to a thirty-eighth aspect when referring back to aspect 37, the ambiguity in the input of the command parser unit 54 relates to an ambiguity associated with the command; or wherein the ambiguity in the output of the command parser unit 54 relates to an ambiguity associated with the setting 52; and/or associated with the device.

According to a thirty-ninth aspect when referring back to one of aspects 35 to 38, the device comprises an ambiguity interface 34₂ for transmitting an ambiguity signal 64 based on the ambiguity information 64 for providing information about a determined ambiguity.

According to a fortieth aspect when referring back to aspect 39, the device is configured for providing the ambiguity signal 64 as a feedback that indicates at least one of: an information identifying the device or an intended receiver of the ambiguity signal; a type of feedback provided; a validity information of the feedback, e.g., for whom the feedback is intended, how long it is valid, which part of the network is subject of the feedback, a priority such as indicating whether the feedback is important or a side information

According to a forty-first aspect when referring back to aspect 40, the type of feedback indicates at least one of: an ambiguity feedback, e.g., indicating an ambiguity of an instruction, the contextual information, the command, the setting of a system behaviour; a positive or negative acknowledge feedback, e.g., acknowledging a successful or failed execution of the command; a contextual request feedback requesting additional contextual information; a system behaviour feedback indicating an observed or expected or unexpected system behaviour responsive to the settings and/or the command; a refinement request indicating a request to refine information to reduce ambiguity.

According to a forty-second aspect when referring back to aspect 41, the type of feedback indicates the refinement request indicating the request to refine information to reduce ambiguity; wherein the refinement request relates to at least one of: a refinement request that allows a decision at the instructing device 50 whether to provide for at least one of an additional contextual information 22, a refined command and a refined instruction; context refinement request indicating a request to provide for an additional contextual information 22; command refinement request indicating a request to provide for a refined instruction and/or a refined command.

According to a forty-third aspect when referring back to one of aspects 35 to 42, the ambiguity processor 58 is configured for providing the ambiguity result 32 so as to indicate at least one of: ambiguity associated with a control unit of the instructing device, e.g., whether the meaning such as left/right indicated in an instruction is unambiguous; ambiguity associated with the instructing device, e.g., a command unit thereof; output related ambiguity associated with the instructing device, e.g., a command unit thereof, providing the command in view of the contextual information and instructions associated hereto; ambiguity associated with a command parser unit of the device; ambiguity associated with the system or process; an indicator whether the command is understood in view of the contextual information; a probability whether the command is understood in view of the contextual information; a context refinement request indicating a request to provide supplementary contextual information about the command chain.

According to a forty-fourth aspect when referring back to aspect 43, the ambiguity processor 58 is configured for determining the probability as a normalized probability in which all determined probabilities sum up to a value corresponding to 100%; or for determining the probability as an unnormalized probability in which all determined probabilities sum up to a value corresponding to a value differing from 100%.

According to a forty-fifth aspect when referring back to one of aspects 25 to 44, the device comprises: a context interface 36₂ for context transfer to directly or indirectly transfer contextual information 22 to the instructing device; and/or an ambiguity interface 34₂ for transmitting ambiguity information to the instructing device 10.

According to a forty-sixth aspect when referring back to aspect 45, the ambiguity interface 34 is connected to a command parser unit 54 configured for accessing/using the contextual information 22 and for generating the setting 52 of the device; and configured to provide the ambiguity information to the instructing device, e.g., a command unit thereof.

According to a forty-seventh aspect when referring back to one of aspects 25 to 46, the device is configured for providing, to the instructing device 10, an acknowledgement information indicating an acknowledgement for the command.

According to a forty-eighth aspect when referring back to one of aspects 25 to 47, the device comprises a control unit configured for implementing and/or executing the setting and for locking at least one function of the device or system response of the command chain based on the command; or for unlocking at least one function of the device or system response of the command chain based on the command.

According to a forty-ninth aspect when referring back to aspect 48, the device is configured for providing a report to the instructing device reporting the locking or reporting the unlocking.

According to a fiftieth aspect when referring back to one of aspects 25 to 49, the contextual information is accessible for the device at least partly at an internal or external data storage 38.

According to a fifty-first aspect, a system comprises: a device of one of aspects 1 to 24 as an instructing device; and a device of one of aspects 25 to 50 as an instructed device.

According to a fifty-second aspect when referring back to aspect 51, the contextual information 22 accessed/used by the instructing device 50 is a first contextual information 22₁; and wherein the contextual information used the instructed device is a second contextual information 22₂; wherein the first contextual information 22₁ and the second contextual information 22₂ are from a same data source, e.g., obtained from a common central or decentral data storage; OR from different data sources, e.g. obtained from local or decentralized data storages; and/or wherein the first contextual information 22₁ and the second contextual information 22₂ are at least partly/partially different from one another or are coincident or are identical.

According to a fifty-third aspect when referring back to aspect 51 or 53, the system comprises a contextual information provider adapted to provide contextual information 22 for the instructed device 50 and/or for the instructing device 10; whilst being not part of the command chain 40.

According to a fifty-fourth aspect when referring back to aspect 53, the first contextual information 22₁ and the second contextual information 22₂ differ from each other in view of at least one considered parameter and/or in view of a value of a same parameter.

According to a fifty-fifth aspect when referring back to one of aspects 52 to 54, the first contextual information 22₁ is restricted to a first information domain; wherein the second contextual information 22₂ is restricted to a second information domain.

According to a fifty-sixth aspect when referring back to aspect 55, the first information domain is associated with a domain of the instructing device 10, a domain of the control unit 16; and/or a domain of a command unit 26 of the instructing device 10; and/or wherein the second information domain is associated with a domain of the instructed device, a domain of a command parser unit of the instructed device 50; and/or a domain of a system or process of the instructed device 50.

According to a fifty-seventh aspect when referring back to one of aspects 51 to 56, the instructing device is a 3^{rd} party controller 10₄ configured for controlling the instructed device.

According to a fifty-eighth aspect when referring back to one of aspects 51 to 57, the instruction is a high-level descriptor of the system behaviour, the system comprising the instructed device 50, intended by the instructing device 10.

According to a fifty-ninth aspect when referring back to one of aspects 51 to 58, the instruction 18 is associated with at least one of: an increase of a data rate provided by the instructed device with a data signal; a reduction of interference generated by the instructed device; an activation or a deactivation of at least a part of a functionality or service of the instructed device; a broadcast provided by the instructed device, e.g., a warning or alert; an execution of an end-to-end measurement or test; an adaption of an antenna radiation pattern or parts of same; an adaption of antenna gain; an adaption of a radio parameter; and a reduction of network energy consumption, e.g. within given constraints.

According to a sixtieth aspect when referring back to one of aspects 51 to 59, the command 24 is to command at least one of: to request or to report capabilities of the instructed device; to decrease or increase a power of the instructed device; to decrease or increase a power of the instructed device by a value specified in the command; to set a power of the instructed device to a minimum or maximum value; to set power step implemented by the instructed device to a value specified in the command; to set a carrier used by the instructed device to a channel specified in the command; to set a carrier frequency used by the instructed device to a frequency specified in the command; to increase or decrease a modulation and coding scheme MCS class used by the instructed device; to move a first beam generated by the instructed device along a direction; to move a first beam generated by the instructed device along a first direction and a second beam generated by the instructed device along a second direction; or to move the first beam and the second beam along a common direction; to move a beam generated by the instructed device along a direction by an amount specified in the command.

According to a sixty-first aspect when referring back to one of aspects 51 to 60, the system comprises a centralised or distributed memory 38 having stored thereon the contextual information.

According to a sixty-second aspect when referring back to one of aspects 51 to 61, the contextual information 22 relates to a context of the instructing device 10 and/or to a context of the instructed device 50.

According to a sixty-third aspect when referring back to one of aspects 51 to 62, the contextual information 22 relates to a context of the instructing device 10 and comprises information indicating at least one of: a capability of the instructing device 50; a manufacturer of the instructing device 50; a type or model of the instructing device 50; an operator of the instructing device 50; a location of the instructing device 50; an operation condition of the instructing device 50; an absolute or relative time; a geolocation; a relative location or co-location; an orientation; a set of conditions; a validity of information.

According to a sixty-fourth aspect when referring back to one of aspects 51 to 63, the contextual information 22 relates to a context of the instructed device 50 and comprises information indicating at least one of: a capability of the instructed device; a manufacturer of the instructed device; a type or model of the instructed device; an operator of the instructed device; a location of the instructed device; an operation condition of the instructed device; an absolute or relative time; a geolocation; a relative location or co-location; an orientation; a set of conditions; a validity of information.

According to a sixty-fifth aspect when referring back to one of aspects 51 to 64, the instructing device 10, the instructed device 50 or a different entity is configured for providing, receiving and/or updating the contextual information 22.

According to a sixty-sixth aspect when referring back to one of aspects 51 to 65, the contextual information 22 relates to an instructing device 10, an instructed device 50 or a different entity.

According to a sixty-seventh aspect when referring back to one of aspects 51 to 66, the instructing device is adapted so as to generate the command signal comprising an indication for the instructed device being a beamforming device such as a repeater or a reconfigurable intelligent surface, RIS, to point a beam of the instructed device towards a specific direction or location or to exclude the specific direction or location from a beam pattern generated by the instructed device.

According to a sixty-eighth aspect when referring back to aspect 67, the specific direction or location is associated with a position of another device such as a communication partner of the instructing device.

According to a sixty-ninth aspect, a method for operating a system having a command chain comprising at least one instructing device and an instructed device comprises: determining 1010 a target behaviour of the instructed device and generating an instruction that indicates the target behaviour; preparing, 1020 at the instructing device, the instruction using a contextual information indicating a context of the command chain and generating a command for the instructed device based on the contextual information and as an incomplete command that misses information with respect to a complete command; transmitting 1030 the command to the instructed device; and deriving 1040, at the instructed device, a setting for the instructed device from the command by deriving missing information in the incomplete command by use of the contextual information; and applying 1050 the setting at the instructed device.

According to a seventieth aspect when referring back to aspect 69, the complete command relates to a command incorporating a complete set of parameters; wherein the incomplete command misses at least a part of the parameters as missing information.

A seventy-first aspect relates to a computer readable digital storage medium having stored thereon a computer program having a program code for performing, when running on a computer, a method according to aspect 69 or 70.

Embodiment address the problem that relates to the manner in which a commander or controller commands or controls a system or process, and, in particular, how the commands are constructed using contextual information and additional knowledge. Although the problem solved and the proposed technical solutions each relate to a command system, aspects of both have a number of similarities with a control system. Embodiments are thus, in parts, explained in connection with a short introduction to control systems together with discussing the problem to be solved in relation to a command system.

Embodiments described herein allow to reduce a need for an a priori knowledge of a systems full instruction set, a reduction of a signalling overhead needed for a controller to control a system-to-be-controlled, a reduction of a latency associated with a controller to control a system-to-be-controlled or the like. Alternatively or in addition, embodiments allow to provide an interoperability of components and devices that comprise a system. Embodiments further offer a forward compatibility.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

ABBREVIATIONS

| Abbreviation | Definition | Further description |
|---|---|---|
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CP | control plane | |
| CP1 | control plane 1 | |
| CP2 | control plane 2 | |
| CPRI | common public radio interface | |
| CSI-RS | channel state information reference signal | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity / identification | |
| IF | intermediate frequency | |
| IIOT | industrial internet of things | |
| I2C | inter-integrated-circuit | A serial interface standard |
| I3C | See I2C | A serial interface standard |
| KPI | key-performance indicator | |
| LNA | low-noise amplifier | |
| LTE | long-term evolution | |
| MCG | master cell group | |
| MCS | modulation coding scheme | |
| MDT | minimization of drive tests | |
| MIMO | multiple-input / multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing E-UTRA user |
| NG-RAN | either a gNB or an NG-eNB | |
| NGSO | non-geostationary orbit | |
| NIC | network interface connection | |
| NR | new radio | |
| NR-U | NR unlicensed | NR operating in unlicensed |
| NTN | non-terrestrial network | |
| OAM | operation and maintenance | |
| OEM | original equipment manufacturer | |
| OTT | over-the-top | |
| ORAN | see open RAN | |
| Open RAN | open radio access network | |
| PCI | physical cell identifier | Also known as PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network information | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SPI | serial peripheral interface | |
| SRS | sounding reference signal | |
| SS | synchronization signal | |
| SSB | synchronization signal block | |
| SSID | service set identifier | |
| SS-PBCH | sounding signal / physical broadcast | |
| TAC | tracking area code | |
| TB | transmission block | |
| TDD | time division duplex | |
| TN | terrestrial network | |
| TSG | technical specification group | |
| UAV | unmanned airborne vehicle | |
| UE | user equipment | |
| UL | uplink | |
| UP | user plane | |
| URLLC | ultra-reliable low latency communication | |
| UTRAN | universal trunked radio access network | |
| V2X | vehicle-to-everything | |
| VCO | voltage-controlled oscillator | |
| VGA | variable gain amplifier | |
| VoIP | voice over internet protocol | |
| vRAN | virtual ran | |
| WI | work item | |
| WLAN | wireless local area network | |

1. A device configured for transmitting a command signal as an instructing device and to an instructed device forming a command chain with the instructing device, the device comprising:
an interface configured for transmitting the command signal;
a control unit configured for providing an instruction signal comprising an instruction associated to a target behaviour of the instructed device;
wherein the device is configured for accessing/using contextual information indicating a context of the command chain and for generating a command from the instruction based on the contextual information; wherein the command is associated with an operation of the instructed device; or providing contextual information indicating a context of the command chain for interpretation of a command belonging to the command chain
wherein the device is configured for transmitting the command signal comprising the command using the interface.

2. The device of claim 1, being adapted for operating in a wireless communication system and to instruct the instructed device as another device of the wireless communication system.

3. The device of claim 1, comprising a command unit configured for accessing/using the contextual information and for generating the command.

4. The device of claim 1, wherein the command chain is a first command chain; wherein the device is adapted for providing contextual information associated with the first command chain; and/or for providing contextual information associated with a second command chain, the device not being part of the second command chain.

5. The device of claim 4, wherein the device is adapted for providing contextual information associated with the second command chain, upon request or based on a triggering event.

6. The device of claim 4, wherein the contextual information comprises a generic information that is generic for a
a type of the instruction;
a type of at least a component of the device;
a type of at least a component of the instructed device;
a description of the process

7. The device of claim 1, wherein the device is adapted for accessing a first digital twin, DT, of the instructed device and for deriving, based on the DT, at least a part of at least one of the contextual information, the instruction and the command; and/or
accessing a second digital twin, DT, of the device and for deriving, based on the DT, at least a part of at least one of the contextual information, the instruction and the command.

8. The device of claim 1, wherein the device, e.g., a command unit thereof, is configured for deriving, from the contextual information, expectedly known information that is expected to be known at the instructed device and to remove or substitute the expectedly known information from the command.

9. The device of claim 1, comprising an ambiguity processor configured for evaluating an ambiguity of the instruction with respect to the contextual information and/or to receive ambiguity information provided by the instructed device to acquire an ambiguity result; wherein the ambiguity processor is configured for providing the ambiguity result to the control unit;
wherein the control unit is configured for reducing the ambiguity based on the ambiguity result.

10. The device of claim 9,
wherein the control unit is configured for providing a new instruction signal comprising a new instruction associated to the target behaviour, the new instruction comprising supplementary information and/or a supplementary instruction when compared to the instruction to reduce the ambiguity; and/or
wherein the control unit is configured for providing supplementary contextual information about the device for decreasing the ambiguity at the instructed device;
and/or wherein the control unit is configured for controlling the device to send a request to the instructed device for providing a supplementary contextual information about the instructed device.

11. The device of claim 10, wherein the control unit is configured for providing the new instruction signal so as to comprise a change in a parameter of the instruction and/or at least one additional parameter when compared to the instruction.

12. The device of claim 10, wherein the device, e.g., a command unit thereof is configured for generating a new command signal comprising a new command based on the new instruction signal and based on the contextual information; wherein, when compared to the command signal, the new command signal comprises at least one of:
information with increased granularity;
an additional data field comprising an additional parameter; and
an additional side constraint for the target behaviour.

13. The device of claim 10, wherein the device, e.g., a command unit thereof is configured for using additional contextual information provided by the device or a different device for providing the new command signal; wherein, based on the additional contextual information the control unit is configured for reducing an amount of information comprised by the new command signal when compared to the instruction signal.

14. The device of claim 9, wherein the device comprises a command unit configured for accessing the contextual information and for generating the command; wherein the ambiguity processor is configured for providing the ambiguity result so as to indicate ambiguity in at least one of an input of the command unit and an output of the command unit.

15. The device of claim 14, wherein the ambiguity in the input of the command unit relates to an ambiguity associated with the control unit; and/or associated with the instruction; or wherein the ambiguity in the output of the command unit relates to an ambiguity associated with the instruction; and/or associated with the command.

16. The device of claim 1, wherein the control unit is configured for an evaluation whether a behaviour of the instructed device corresponds to the target behaviour.

17. The device of claim 18, wherein the control unit is configured for using, for the evaluation at least one of:
a measurement report reporting about a measurement associated with the behaviour;
an updated contextual information being updated based on the behaviour;
a feedback received from the instructed device.

18. The device of claim 18, wherein the control unit is configured, within the evaluation, for comparing the behaviour of the instructed device with the target behaviour and for determining a deviation between the behaviour of the instructed device and the target behaviour; and for
providing an updated instruction with regard to the target behaviour or an updated target behaviour based on the deviation.

19. The device of claim 18, wherein the control unit is configured for correlating the deviation with the contextual information available to the device or the instructed device and for updating the contextual information and/or considering, in the updated instruction, the deviation.

20. The device of claim 1, wherein the control unit and a command unit of the device, the command unit configured for accessing the contextual information and for generating the command; are functionally arranged totally within the instructing device or at most partly as a network entity of a network comprising the instructing device.

21. The device of claim 1 configured for:
context transfer to directly or indirectly transfer contextual information to the instructed device; and/or
receiving and processing ambiguity information from the instructed device, the ambiguity information indicating an ambiguity resulting from the command the ambiguity determined by the instructed device.

22. The device of claim 1, wherein the command signal is a first command signal, wherein the device is configured for using additional contextual information provided by the device or a different device for providing a second command signal for a same instruction signal; wherein, based on the additional contextual information the device is configured for reducing an amount of information comprised by the second command signal when compared to the first command signal.

23. A device configured for operating based on a received command as an instructed device of a command chain, the device comprising:
an interface configured for receiving a command signal comprising the command;
wherein the device is configured for accessing/using contextual information indicating a context of the command chain and for generating a setting of the device from the command based on the contextual information; wherein the setting is associated with an operation of the device;
wherein the device is configured for implementing and/or executing the setting.

24. The device of claim 23, being adapted for operating in a wireless communication system and to receive the command signal from another device of the wireless communication system.

25. The device of claim 23, wherein the device comprises a command parser unit configured for accessing/using the contextual information and for generating the setting of the device.

26. The device of claim 23, wherein the command chain is a first command chain; wherein the device is adapted for providing contextual information associated with the first command chain; and/or for providing contextual information associated with a second command chain, the device not being part of the second command chain.

27. The device of claim 26, wherein the device is adapted for providing contextual information associated with the second command chain, upon request or based on a triggering event.

28. The device of claim 23, wherein the device is adapted for accessing a first digital twin, DT, of the instructing device and for deriving, based on the first DT, at least a part of at least one of the contextual information, the setting and the operation; and/or
wherein the device is adapted for accessing a second digital twin, DT, of the device and for deriving, based on the second DT, at least a part of at least one of the contextual information, the setting and the operation.

29. The device of claim 23, wherein the settings relate to a control of a subsystem of the device; wherein the device, e.g., a command parser unit thereof, is configured for determining a plurality of settings for a same or different subsystems; the plurality of settings describing a simultaneous or sequential control for the same or different subsystems as a solution to follow the received command.

30. The device of claim 23, wherein the device, e.g., a command parser unit thereof is configured for deriving, from the command a missing information with respect to a valid setting of the device; and to derive, from the contextual information, the missing information to acquire at least one valid setting.

31. The device of claim 30, wherein the device, e.g., a command parser unit thereof, is configured for providing a plurality of valid settings based on the command in a case where the contextual information provides for an ambiguous determination of the setting based on the missing information.

32. The device of claim 30, comprising an ambiguity processor configured for providing an ambiguity information in a case where the contextual information provides for an ambiguous determination of the setting based on the missing information.

33. The device of claim 23, comprising an ambiguity processor configured for evaluating an ambiguity of the command with respect to the contextual information to acquire ambiguity information; wherein the ambiguity processor is configured for providing the ambiguity information to an instructing device from which the command signal and/or to an entity of the device to cause the entity to provide supplementary contextual information.

34. The device of claim 32, wherein the device comprises a command parser unit configured for accessing/using the contextual information and for generating the setting of the device; wherein the ambiguity processor is configured for providing the ambiguity result so as to indicate ambiguity in at least one of an input of the command parser unit and an output of the command parser unit.

35. The device of claim 34, wherein the ambiguity in the input of the command parser unit relates to an ambiguity associated with the command; or wherein the ambiguity in the output of the command parser unit relates to an ambiguity associated with the setting; and/or associated with the device.

36. The device of claim 32, wherein the device is configured for transmitting an ambiguity signal based on the ambiguity information for providing information about a determined ambiguity.

37. The device of claim 32, wherein the ambiguity processor is configured for providing the ambiguity result to indicate a probability whether the command is understood in view of the contextual information; wherein the ambiguity processor is configured for determining the probability as a normalized probability in which all determined probabilities sum up to a value corresponding to 100%; or for determining the probability as an unnormalized probability in which all determined probabilities sum up to a value corresponding to a value differing from 100%.

38. The device of claim 23, configured for:
context transfer to directly or indirectly transfer contextual information to the instructing device; and/or
transmitting ambiguity information to the instructing device.

39. The device of claim 38, comprising a command parser unit configured for accessing/using the contextual information and for generating the setting of the device; and configured to provide the ambiguity information to the instructing device, e.g., a command unit thereof.

40. The device of claim 23, wherein the device is configured for providing, to the instructing device, an acknowledgement information indicating an acknowledgement for the command.

41. The device of claim 23, wherein the device comprises a control unit configured for implementing and/or executing the setting and for locking at least one function of the device or system response of the command chain based on the command; or for unlocking at least one function of the device or system response of the command chain based on the command.

42. The device of claim 41, wherein the device is configured for providing a report to the instructing device reporting the locking or reporting the unlocking.

43. System comprising:
a device of claim 1 as an instructing device; and
a device of claim 23 as an instructed device.

44. The system of claim 43, wherein the system is a wireless communication system.

45. The system of claim 43, comprising a contextual information provider adapted to provide contextual information for the instructed device and/or for the instructing device; whilst being not part of the command chain.

46. The system of claim 43, wherein the contextual information accessed/used by the instructing device is a first contextual information; and wherein the contextual information used the instructed device is a second contextual information;
wherein the first contextual information and the second contextual information are from a same data source, e.g., acquired from a common central or decentral data storage; OR from different data sources, e.g. acquired from local or decentralized data storage(s); and/or
wherein the first contextual information and the second contextual information are at least partly/partially different from one another or are coincident or are identical.

47. The system of claim 46, wherein the first contextual information and the second contextual information each relate to at least one parameter and differ from each other in view of at least one considered parameter and/or in view of a value of a same parameter.

48. The system of claim 46, wherein the first contextual information is restricted to a first information domain; wherein the second contextual information is restricted to a second information domain.

49. The system of claim 48, wherein the first information domain is associated with a domain of the instructing device, a domain of the control unit; and/or a domain of a command unit of the instructing device; and/or
wherein the second information domain is associated with a domain of the instructed device, a domain of a command parser unit of the instructed device; and/or a domain of a system or process of the instructed device.

50. The system of claim 43, wherein the instructing device is a 3rd party controller configured for controlling the instructed device.

51. The system of claim 43, wherein the instruction is a high-level descriptor of the system behaviour, the system comprising the instructed device, intended by the instructing device.

52. The system of claim 43, comprising a memory accessible for the instructed device and/re the instructing device and having stored thereon the contextual information.

53. The system of claim 43, wherein the contextual information relates to a context of the instructing device and/or to a context of the instructed device.

54. The system of claim 43, wherein the contextual information relates to a context of the instructing device and comprises information indicating at least one of:
a capability of the instructing device;
a manufacturer of the instructing device;
a type or model of the instructing device;
an operator of the instructing device;
a location of the instructing device;
an operation condition of the instructing device;
an absolute or relative time;
a geolocation;
a relative location or co-location;
an orientation;
a set of conditions;
a validity of information.

55. The system of claim 43, wherein the contextual information relates to a context of the instructed device and comprises information indicating at least one of:
a capability of the instructed device;
a manufacturer of the instructed device;
a type or model of the instructed device;
an operator of the instructed device;
a location of the instructed device;
an operation condition of the instructed device;
an absolute or relative time;
a geolocation;
a relative location or co-location;
an orientation;
a set of conditions;
a validity of information.

56. The system of claim 43, wherein at least one of the instructing device, the instructed device and a different entity is configured for at least one of providing, receiving and updating the contextual information.

57. The system of claim 43, wherein the contextual information relates to the instructing device, the instructed device or a different entity.

58. The system of claim 43, wherein the instructing device is adapted so as to generate the command signal comprising an indication for the instructed device being a device capable of beamforming to point a beam of the instructed device towards a specific direction or location or to exclude the specific direction or location from a beam pattern generated by the instructed device.

59. The system of claim 58, wherein the specific direction or location is associated with a position of another device such as a communication partner of the instructing device.

60. Method for operating a system having a command chain comprising at least one instructing device and an instructed device, the method comprising:
determining a target behaviour of the instructed device and generating an instruction that indicates the target behaviour;
preparing, at the instructing device, the instruction using a contextual information indicating a context of the command chain and generating a command for the instructed device based on the contextual information and as an incomplete command that misses information with respect to a complete command;
transmitting the command to the instructed device; and
deriving, at the instructed device, a setting for the instructed device from the command by deriving missing information in the incomplete command by use of the contextual information; and
applying the setting at the instructed device.

61. The method of claim 60, wherein the complete command relates to a command incorporating a complete set of parameters; wherein the incomplete command misses at least a part of the parameters as missing information.

62. A non-transitory digital storage medium having a computer program stored thereon to perform the method for operating a system having a command chain comprising at least one instructing device and an instructed device, the method comprising:
determining a target behaviour of the instructed device and generating an instruction that indicates the target behaviour;
preparing, at the instructing device, the instruction using a contextual information indicating a context of the command chain and generating a command for the instructed device based on the contextual information and as an incomplete command that misses information with respect to a complete command;
transmitting the command to the instructed device; and
deriving, at the instructed device, a setting for the instructed device from the command by deriving missing information in the incomplete command by use of the contextual information; and
applying the setting at the instructed device,
when said computer program is run by a computer.
